(19) United States
(12) Patent Application Publication
(10) Pub. No.: US 2026/0140676 A1
(43) Pub. Date: May 21, 2026

(54) STORAGE MEDIUM STORING APPLICATION PROGRAM, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: TATEKI NARITA, Tokyo (JP)

(21) Appl. No.: 19/386,796

(22) Filed: Nov. 12, 2025

(30) Foreign Application Priority Data
Nov. 19, 2024 (JP) 2024-201646

(51) Int. Cl. G06F 3/12

(52) U.S. Cl. CPC G06F 3/1228; G06F 3/1205

(57) ABSTRACT

A mechanism that is capable of generating one continuous data as data of documents divided into a plurality of bundles. A non-transitory computer-readable storage medium storing an application program including: supporting a standard driver provided from a provider of an operating system of an information processing apparatus, causing the information processing apparatus to execute a control method including: causing a display to display a reception screen on which a second instruction that instructs an image processing apparatus to read a second document following a first document after reading the first document based on a first instruction that instructs the image processing apparatus to read the first document, and making image data of the first document read based on the first instruction and image data of the second document read based on the second instruction into one file.

### BACKGROUND

### Field of the Technology

The aspect of the embodiments relates to a storage medium storing an application program, a control method for an information processing apparatus, and the information processing apparatus.

### Description of the Related Art

A host computer (an information processing apparatus) capable of processing information with a scanning apparatus (scanner) is communicably connected to the scanning apparatus that performs image reading, that is, scanning. As control software to control the scanning apparatus, for example, a scan driver installed in the host computer from the scanning apparatus is used. The scan driver enables the host computer to issue a scan instruction to the scanning apparatus. An operating system (hereinafter referred to as an "OS"), which is basic software, is installed in the host computer in advance. The scan driver is configured in accordance with specifications defined by the OS and can be called from the OS to operate. In addition, such a scan driver is different for each vendor that supplies the scanning apparatus, that is, a model-specific scan driver suitable for each scanning apparatus.

In recent years, Windows (registered trademark) provides a standard class driver (hereinafter, may be referred to as a "standard driver") that can be commonly used even in scanning apparatuses supplied by a plurality of different vendors. Such a standard driver is incorporated in the OS in advance. The standard driver can be used by connecting an arbitrary scanning apparatus to a host computer having the OS in which the standard driver is incorporated. This enables to omit installation of the scan driver specific to the model. Further, it is assumed that the standard driver is configured to be able to designate a scan function in the scanning apparatus according to scan function information generated based on information obtained from the scanning apparatus. This allows designation of a scan function for each scanning apparatus with one standard driver.

Since the standard driver can be commonly used for scanning apparatuses of a plurality of different vendors, for example, there is a case where it is impossible to cause a scanning apparatus of a predetermined vendor to execute a part of functions in the scanning apparatus. Japanese Patent Laid-Open No. 2021-033526 (JP-A-2021-033526, Counterpart of US 20210055893 A1) discloses a program that expands a print function of a print service that can be generally used regardless of the model and vendor of the image forming apparatus. This enables execution of a print function that cannot be executed only by a generally used print service by operating a print setting screen corresponding to an individual image forming apparatus for each model or vendor.

As described above, the scan driver is different for each vendor that supplies a scanning apparatus, that is, the scan driver is a model-specific scan driver suitable for each scanning apparatus. Such a scan driver may have a continuous reading setting function that is used when a scan instruction is transmitted to the scanning apparatus. For example, a plurality of documents exceeding the maximum number of sheets shall be placed on a feeder of the scanning apparatus. In this case, when the continuous reading setting function is used, the documents are divided into two bundles, the first bundle is placed on the feeder and read. The second bundle is held in a reading standby state during the reading of the first bundle. And then the second bundle is placed on the feeder and read. By such reading, one continuous data can be generated as the data of the plurality of documents. However, the standard driver cannot instruct the scanning apparatus to read a divided bundle of documents that has not been read yet, whenever each bundle of documents has been read. As a result, there is a problem that one continuous data cannot be generated as the data of documents divided into the plurality of bundles.

### SUMMARY

The present disclosure provides a mechanism that is capable of generating one continuous data as data of documents divided into a plurality of bundles.

Accordingly, an aspect of the embodiments provides a non-transitory computer-readable storage medium storing an application program including supporting a standard driver provided from a provider of an operating system of an information processing apparatus, causing the information processing apparatus to execute a control method including causing a display to display a reception screen on which a second instruction that instructs an image processing apparatus to read a second document following a first document after reading the first document based on a first instruction that instructs the image processing apparatus to read the first document, and making image data of the first document read based on the first instruction and image data of the second document read based on the second instruction into one file.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a scan system according to a first embodiment.

FIG. 2A and FIG. 2B are block diagrams illustrating software configurations of the scan system.

FIG. 3A, FIG. 3B, and FIG. 3C are views illustrating examples of screens displayed on a display unit of the scan system.

FIG. 4 is a flowchart illustrating a process in which a scan function expansion unit in the first embodiment edits scan function information.

FIG. 5A, FIG. 5B, and FIG. 5C are views illustrating examples of lists of scan information.

FIG. 6 is a sequence chart illustrating a process executed among a scan application, a general-purpose scan software, an expansion application, and a scanning apparatus in the first embodiment after the scan application accepts a scan setting.

FIG. 7 is a flowchart illustrating a process executed by the expansion application in the first embodiment.

FIG. 8A is a flowchart illustrating a process executed by the scanning apparatus in the first embodiment.

FIG. 8B is a view illustrating an example of a screen displayed on the display unit of the scan system.

FIG. 9 is a flowchart illustrating a process in which a scan function expansion unit in the second embodiment edits the scan function information.

FIG. 10 is a sequence chart illustrating a process executed among a scan application, a general-purpose scan software, an expansion application, and a scanning apparatus in the second embodiment after the scan application accepts a scan setting.

FIG. 11 is a flowchart illustrating a process executed by the expansion application in the second embodiment.

FIG. 12 is a sequence chart illustrating a process executed among a scan application, a general-purpose scan software, an expansion application, and a scanning apparatus in a third embodiment after the scan application accepts a scan setting.

FIG. 13 is a sequence chart illustrating a process executed among a scan application, a general-purpose scan software, an expansion application, and a scanning apparatus in a variation example of the third embodiment after the scan application accepts a scan setting.

FIG. 14 is a sequence chart illustrating a process executed among a scan application, a general-purpose scan software, an expansion application, and a scanning apparatus in a fourth embodiment after the scan application accepts a scan setting.

FIG. 15 is a flowchart illustrating a process executed by the expansion application in the fourth embodiment.

FIG. 16 is a sequence chart illustrating a process executed among a scan application, a general-purpose scan software, an expansion application, and a scanning apparatus in a fifth embodiment after the scan application accepts a scan setting.

FIG. 17 is a flowchart illustrating a process executed by the expansion application in the fifth embodiment.

FIG. 18 is a view illustrating an example of a screen displayed on the display unit of the scan system according to a sixth embodiment.

FIG. 19 is a sequence chart illustrating a process executed among a scan application, a general-purpose scan software, an expansion application, and a scanning apparatus in the sixth embodiment after the scan application accepts a scan setting.

FIG. 20 is a flowchart illustrating a process executed by the expansion application in the sixth embodiment.

### DESCRIPTION OF THE EMBODIMENTS

Hereinafter, embodiments of the present disclosure will be described in detail with reference to the drawings. However, configurations described in the following embodiments are merely examples, and the scope of the present disclosure is not limited by the configurations described in the embodiments. For example, each unit constituting the present disclosure can be replaced with any configuration capable of exhibiting the same function. In addition, an arbitrary constituent may be added. Any two or more configurations (features) of the embodiments can be combined.

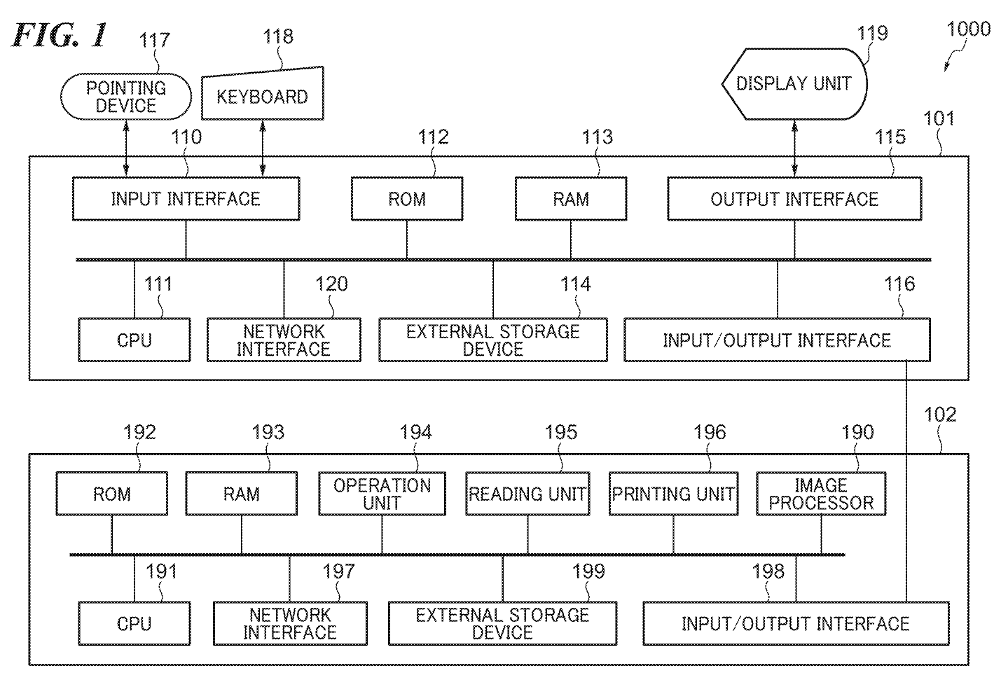

Hereinafter, a first embodiment will be described with reference to FIG. 1 to FIG. 8B.

FIG. 1 is a block diagram illustrating a hardware configuration of a scan system according to the first embodiment. As illustrated in FIG. 1, the scan system 1000 includes a host computer 101, a scanning apparatus (scanner) 102, a pointing device 117, a keyboard 118, and a display unit 119, which are communicably connected to each other. The host computer 101 is an information processing apparatus and has an input interface 110, a CPU 111, a ROM 112, a RAM 113, an external storage device (storage medium) 114, an output interface 115, an input/output interface 116, and a network interface 120. As the host computer 101, for example, a desktop personal computer can be used, but this is not limiting, and for example, a notebook personal computer, a tablet terminal, a smartphone, or the like can also be used.

The CPU 111 is a computer that executes a program stored in the ROM 112 or the external storage device 114. In the present embodiment, the CPU 111 can execute a function and process of the host computer 101, that is, each step (a control method) described later, by performing a process in accordance with a code of a program stored in the ROM 112. The ROM 112 stores an initialization program etc.

The external storage device 114 stores an application program group, an operating system (OS), print data generation software, and other various kinds of data. In this embodiment, Windows (registered trademark) 11 of Microsoft (registered trademark) is installed in the host computer 101 as the OS. The external storage device 114 is not particularly limited, and for example, an HDD (Hard Disk Drive), an SSD ( Solid State Drive), or the like may be used.

The RAM 113 is used as a work memory when various programs stored in the external storage device 114 are executed, and the various programs can operate in the host computer 101. The input interface 110 is connected to the pointing device 117 and the keyboard 118 as input devices. The output interface 115 is connected to the display unit 119 as a display device. On the display unit 119, for example, a scan setting screen 300A, an advanced setting screen 300C, and the like, which will be described later, are displayed.

The network interface 120 controls data transfer with an external apparatus via a network. The scanning apparatus 102 is connected to the input/output interface 116. Accordingly, the host computer 101 can communicate with scanning apparatuses of a plurality of manufacturers regardless of the manufacturer of the scanning apparatus 102, that is, can process information with the scanning apparatuses of a plurality of manufacturers. The host computer 101 and the scanning apparatus 102 may be connected by wire or wirelessly.

The scanning apparatus 102 includes an image processor 190, a CPU 191, a ROM 192, a RAM 193, an operation unit 194, a reading unit 195, a printing unit 196, a network interface 197, an input/output interface 198, and an external storage device 199. The CPU 191 is a computer that executes programs stored in the ROM 192 and the external storage device 199, and totally controls the scanning apparatus 102. The ROM 192 is a memory storing programs. The RAM 193 is a memory temporarily storing a program and image data.

The operation unit 194 can issue various operation instructions to the scanning apparatus 102. The operation unit 194 is configured to be able to display various pieces of information such as a state of the scanning apparatus 102. The reading unit 195 reads (scans) an image of a document. The printing unit 196 prints an image on a sheet on the basis of, for example, image data generated by reading an image of a document by the reading unit 195. The printing unit 196 may be omitted.

The network interface 197 controls data transfer with an external apparatus via a network. The host computer 101 is connected to the input/output interface 198. Image data generated by reading an image of a document by the reading unit 195 is input into the image processor 190, for example. Then, the image processor 190 performs various editing processes on the image data.

The scanning apparatus 102 is not particularly limited as long as it has a reading function to read a document, that is, a scan function, but for example, an image processing apparatus such as a multi-function peripheral (MFP) can be used.

The scanning apparatus 102 includes a flatbed (not illustrated) and a feeder (not illustrated). The flatbed is a first reading spot on which one document subjected to the reading function is placed. The feeder is a second reading spot that is disposed at a position different from the flatbed and on which a plurality of documents subjected to the reading function are placed. In addition, when a multifunction peripheral is used as the scanning apparatus 102, the printing unit 196 employs an electrophotographic system in the present embodiment, but this is not limited, and may employ an inkjet system. In addition, although the host computer 101 and the scanning apparatus 102 are configured as separate apparatuses in the present embodiment, this is not limited thereto. For example, the host computer 101 and the scanning apparatus 102 may be configured as an integrated apparatus.

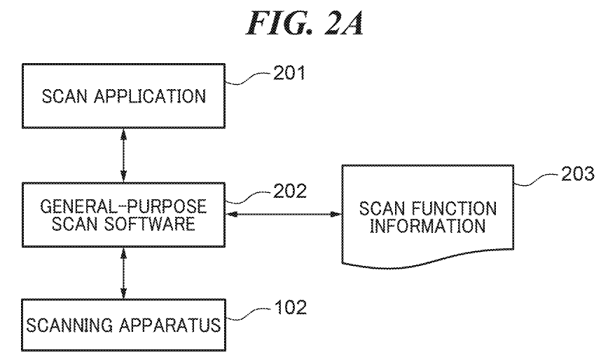

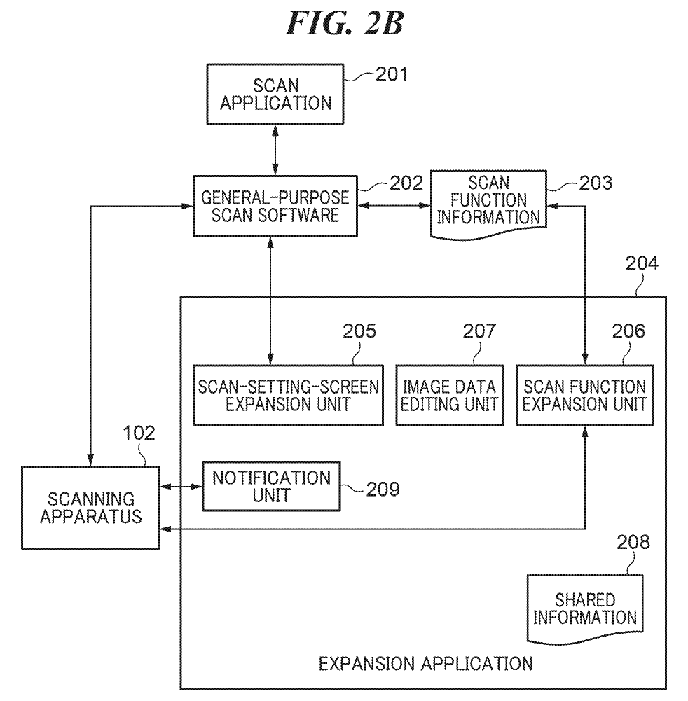

FIG. 2A and FIG. 2B are block diagrams illustrating software configurations of the scan system. FIG. 2A is the diagram illustrating a general configuration in a case where an expansion application (application program) 204 is not associated with a general-purpose scan software (standard driver) 202 and the scanning apparatus 102. FIG. 2B is the diagram illustrating a configuration in a case where the expansion application 204 is associated with the general-purpose scan software 202 and the scanning apparatus 102.

The general-purpose scan software 202 is a standard driver that is provided from a provider of the OS and is incorporated in the OS in advance. The standard driver is a class driver (general-purpose program) that can be used in common, for example, at the time of scanning (at the time of image reading), for scanning apparatuses of a plurality of manufacturers. The standard driver is provided as one of functions in a package of the OS together with the OS. The standard driver can perform process on various scanning apparatuses by using a standardized scan method. This enables the standard driver to generate and output instructions that can be interpreted by scanning apparatuses of a plurality of manufacturers. The standard driver is not particularly limited, and for example, a program that operates on the basis of the IPP (Internet Printing Protocol) is used. The general-purpose scan software 202 is installed (incorporated) in the OS in advance.

The expansion application 204 is a program that supports, that is, assists the general-purpose scan software 202 (a program that executes a control method that performs control to support the general-purpose scan software 202). Although the expansion application 204 is an expansion program that can expand a function that cannot be executed by the general-purpose scan software 202 to the scanning apparatus 102 in the present embodiment, this is not limited. For example, the expansion application 204 may be a program that improves the convenience of the function that can be executed by the general-purpose scan software 202 to the scanning apparatus 102. The expansion application 204 is stored in the external storage device 114 together with the OS including the general-purpose scan software 202, for example. Accordingly, the host computer 101 includes the general-purpose scan software 202 and the expansion application 204.

First, the configuration in which the expansion application 204 is not associated with the general-purpose scan software 202 and the scanning apparatus 102 will be described with reference to FIG. 2A. The scan application 201 is software that captures a content (image data) generated by the scanning in the scanning apparatus 102. The scan application 201 is not particularly limited, and may be a document creation application or an image editing application, for example. Upon receiving a scan request from a user, the scan application 201 issues a scan instruction to the OS. The scan instruction includes scan setting information for instructing operations of the general-purpose scan software 202 and the scanning apparatus 102.

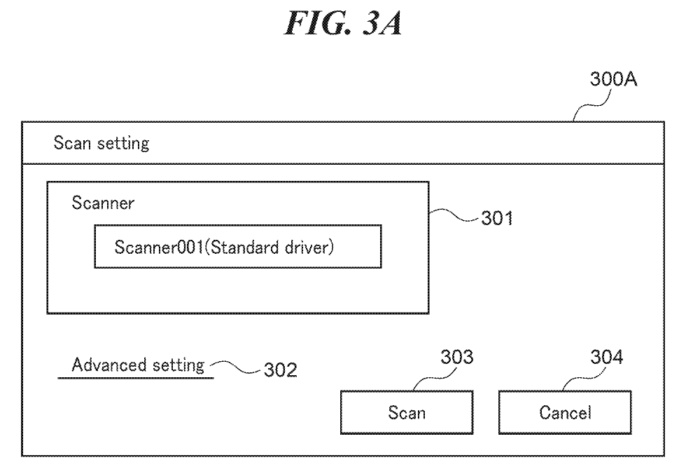

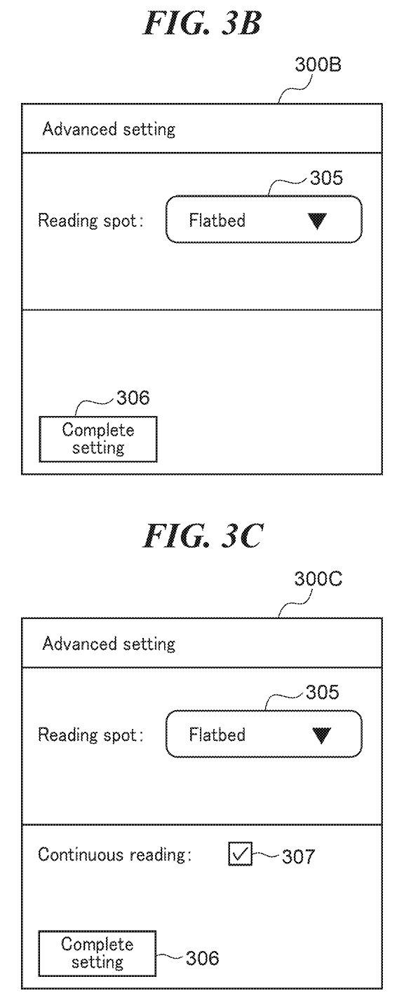

The scan application 201 can cause the display unit 119 to display a scan setting screen 300A provided by any of the general-purpose scan software 202, the OS, and the scan application 201 in order to issue the scan instruction. Further, when a control 302B on the scan setting screen 300A (see FIG. 3A) is pressed, for example, an advanced setting screen 300B (see FIG. 3B) can be displayed on the display unit 119. The scan setting screen 300A, the advanced setting screen 300B, and the advanced setting screen 300C will be described later.

The scan setting screen 300A includes a setting item indicating a settable scan function and a control item indicating a set value of the settable scan function in accordance with capability information obtained by the general-purpose scan software 202, that is, information settable as the scan setting. The "capability information" is related to a scanning capability of the scanning apparatus 102. It is also possible to determine whether the capability information includes information that enables to display the advanced setting screen 300C. Then, as a result of this determination, when it is determined that the information that enables to display the advanced setting screen 300C is included, the advanced setting screen 300C can be displayed.

On the other hand, when it is determined that the information that enables the display of the advanced setting screen 300C is not included, the advanced setting screen 300C is not displayed. In this manner, the expansion application 204 can switch whether to display the advanced setting screen 300C according to the capability information of the scanning apparatus 102.

The scan function information 203 is data indicating all settable scan functions, set values thereof, exclusive relationships between set values, and the like. The scan function information 203 is included in the configuration file of the general-purpose scan software 202 and is stored in the external storage device 114 as an unchangeable file. The scan function information 203 can also be dynamically generated by the general-purpose scan software 202. Specifically, the general-purpose scan software 202 obtains attribute data of the scanning apparatus 102 from the scanning apparatus 102. The general-purpose scan software 202 generates the scan function information 203 in accordance with attribute information in the attribute data. When the scan function information 203 is dynamically generated, the generated scan function information 203 can be edited. The attribute data of the scanning apparatus 102 includes attribute information indicating functions (capabilities of the scanning apparatus 102) that can be designated by the scanning apparatus 102 and set values related to the attribute information, and these are saved in the RAM 113.

With such a configuration, the general-purpose scan software 202 allows a user to designate the scan function available in the scanning apparatus 102 according to a model of the scanning apparatus 102 connected to the host computer 101. Accordingly, regardless of the model of the scanning apparatus 102, that is, even when the scanning apparatus 102 having a different function or the scanning apparatus 102 developed by a different scanner manufacturer is connected, the user can designate the scan function available in the scanning apparatus 102.

In the present embodiment, the general-purpose scan software 202 is a standard class driver that executes scanning based on a standard scan protocol called Mopria. Specifically, as described above, the general-purpose scan software 202 is not a unique scan driver corresponding to the model of the scanning apparatus 102, but a standard class driver that can be commonly used by scanning apparatuses of a plurality of scanner manufacturers regardless of a scanner manufacturer. The general-purpose scan software 202 obtains the capability information of the scanning apparatus 102 and generates the scan function information 203 based on the capability information.

Also, the general-purpose scan software 202 may be associated with the expansion application 204. Accordingly, the general-purpose scan software 202 can execute a function that is not included in the general-purpose scan software 202. For example, when the general-purpose scan software 202 causes the scanning apparatus 102 to execute the scan function, the general-purpose scan software 202 cannot cause the scanning apparatus 102 to execute the reading function for a second document following a first document after executing the reading function for the first document. That is, when the scanning apparatus 102 executes the scan function, the general-purpose scan software 202 cannot receive a setting of continuous reading for reading a plurality of bundles of documents separately and generating one continuous data. As described above, the general-purpose scan software 202 does not support a continuous reading function. This is because the continuous reading function can be executed by a scanning apparatus manufactured by a specific scanner manufacturer.

The expansion application 204 can expand the function of the general-purpose scan software 202 so as to enable execution of a function that cannot be executed only by the general-purpose scan software 202. In the present embodiment, the general-purpose scan software 202 cannot perform the continuous reading function and the expansion application 204 can expand the function of the general-purpose scan software 202 so as to enable execution of the continuous reading function, but this is not limited. For example, the general-purpose scan software 202 may execute a part of the continuous reading function, and the expansion application 204 may compensate for the shortage of the continuous reading function to further expand an execution range.

Next, a configuration in which the expansion application 204 is associated with the general-purpose scan software 202 and the scanning apparatus 102 will be described with reference to FIG. 2B. As shown in FIG. 2B, unlike FIG. 2A, the expansion application 204 is added. That is, the host computer 101 includes the scan application 201, the general-purpose scan software 202, the scan function information 203, and the expansion application 204. The expansion application 204 is software to expand the function of the general-purpose scan software 202 and may be simply referred to as "scan software".

The expansion application 204 is software that is not included in the OS in advance (not packaged together). Therefore, the expansion application 204 is downloaded from a server (not shown) via the Internet and installed in the host computer 101 by the user operating the host computer 101. Alternatively, the expansion application 204 may be automatically installed in response to the connection of the scanning apparatus 102 to the host computer 101. Specifically, when the scanning apparatus 102 is connected to the host computer 101, the OS of the host computer 101 obtains device identification information from the scanning apparatus 102. The OS may download the expansion application 204 corresponding to the device identification information from the server via the Internet and install the expansion application 204. As a result, the general-purpose scan software 202 and the expansion application 204 are held as different control programs in the host computer 101.

Note that the general-purpose scan software 202 and the expansion application 204 may be updated and upgraded. In this case, the update process of the general-purpose scan software 202 and the update process of the expansion application 204 may be performed at the same timing or may be performed at different timings. A trigger to obtain the general-purpose scan software 202 and a trigger to obtain the expansion application 204 by the host computer 101 may be the same or different. In addition, when the expansion application 204 is installed, the OS associates the expansion application 204 with the general-purpose scan software 202 and the scanning apparatus 102.

As illustrated in FIG. 2B, the expansion application 204 can exchange information (transmit and receive information) with the general-purpose scan software 202 and with the scanning apparatus 102. That is, the expansion application 204 is associated with the general-purpose scan software 202 and the scanning apparatus 102. In the present embodiment, the expansion application 204 includes a scan-setting-screen expansion unit 205, a scan function expansion unit 206, an image data editing unit 207, and a notification unit 209.

The expansion application 204 includes shared information 208 that can be accessed from each of the scan-setting-screen expansion unit 205, the scan function expansion unit 206, the image data editing unit 207, and the notification unit 209. The shared information 208 is a file stored in the external storage device 114 or information stored in the RAM 113. The expansion application 204 can write and read information to and from the shared information 208 by using an API (Application Program Interface) provided by the OS.

The expansion application 204 may terminate the operation of the expansion application 204 as a whole in accordance with the end of the process of each of the scan-setting-screen expansion unit 205, the scan function expansion unit 206, the image data editing unit 207, and the notification unit 209. In this case, the OS activates the expansion application 204 whenever a process execution request is received from each unit. In addition, the expansion application 204 may cancel the process during the process of each of the scan-setting-screen expansion unit 205, the scan function expansion unit 206, the image data editing unit 207, and the notification unit 209. In this case, the OS deletes a job in processing.

As described above, the scan application 201 issues a scan instruction to the OS in response to a scan request from a user. In addition, the scan application 201 can display the scan setting screen. In the configuration shown in FIG. 2B, the scan application 201 can display the scan setting screen 300A (an advanced setting screen 300C) provided by the scan-setting-screen expansion unit 205 (the expansion application 204). The scan-setting-screen expansion unit 205 can store an advanced setting set by the user in the shared information 208.

The image data editing unit 207 obtains image data from the scanning apparatus 102. Then, the image data editing unit 207 may edit the image data after obtaining the image data. The image data editing unit 207 obtains advanced setting information from the shared information 208 and edits the image data in accordance with the advanced setting information. The expansion application 204 may edit the image data obtained by the general-purpose scan software 202 in accordance with the advanced setting information. Even in the case of the configuration in FIG. 2B, the continuous reading function may not be executed. In this case, the general-purpose scan software 202 may transmit the scan request instruction to the scanning apparatus 102 without passing through the expansion application 204.

The scan function expansion unit 206 is able to edit the scan function information 203 generated by the general-purpose scan software 202 or the OS. This enables addition of a function provided by the expansion application 204. In addition, the scan function expansion unit 206 can add a function (for example, the continuous reading function) that can be executed by the scanning apparatus 102 but cannot be executed by the general-purpose scan software 202 and an exclusive relationship between set values of the scan function. The OS activates the scan function expansion unit 206 when the expansion application 201 is first associated with the scanning apparatus 102 and the general-purpose scan software 202. The OS may activate the scan function expansion unit 206 at a timing other than this (for example, at the time of OS activation). Even when a function related to scanning is expanded later by such activation, the scan function expansion unit 206 can detect the expanded function and add the expanded function to the scan function information 203.

The notification unit 209 can notify a user of an occurrence of an error that occurs in the scanning apparatus 102. For example, when a reading jam error occurs in the scanning apparatus 102, the general-purpose scan software 202 detects the occurrence of the error. The OS displays the occurrence of the reading jam error, which is a detection result of the general-purpose scan software 202, as a message on the display unit 119 by a notification function called toast notification, which is one of the functions of the OS. When the user operates the toast notification, the notification unit 209 is called by the OS, and a user interface screen (UI screen) of the notification unit 209 is displayed. On the user interface screen, for example, a detailed message related to the reading jam error and a jam releasing method can be displayed.

As described above, in the present embodiment, the expansion application 204 has the following four functions. The first is a function of displaying a setting screen. This function is performed by the scan-setting-screen expansion unit 205. The second is a function of editing the image data in accordance with the advanced setting information. This function is performed by the image data editing unit 207. The third is a function of expanding a function that can be designated by the image data generation software. This function is performed by the scan function expansion unit 206. The fourth is a function of displaying a screen in response to occurrence of an error in the scanning apparatus 102. This function is performed by the notification unit 209. The configuration of the expansion application 204 is not limited to the configuration having all the four functions described above. The expansion application 204 preferably has at least one of the four functions, and may have another function.

FIG. 3A, FIG. 3B, and FIG. 3C are views illustrating examples of screens displayed on the display unit of the scan system. FIG. 3A shows the scan setting screen displayed by the scan application 201. FIG. 3B shows the advanced setting screen that is displayed in a case where the expansion application 204 is not associated. FIG. 3C shows the advanced setting screen displayed in a case where the expansion application 204 is associated. Note that the units and modules that display the screens are not particularly limited. For example, the scan-setting-screen expansion unit 205 may be configured to only generate the display screen. In such a case, the scan-setting-screen expansion unit 205 transmits the generated display screen to the scan application 201 via the general-purpose scan software 202. The scan application 201 may be configured to display the obtained display screen.

The scan setting screen 300A shown in FIG. 3A is the screen on which a setting relating to scanning by the scanning apparatus 102 can be set. The scan setting screen 300A includes controls (buttons) 301, 302, 303, and 304. The control 301 allows a user to select and set the scanning apparatus used for reading a document. In FIG. 3A, the scanning apparatus used for reading a document is set to “Scanner 001 (Standard driver)” as an example. The control 302 allows the user to display a screen on which advanced setting related to scanning is received. The control 303 allows the user to instruct the start of scanning by the scanning apparatus 102. The control 304 allows the user to instruct cancellation of the scanning by the scanning apparatus 102.

In the case where the expansion application 204 is not associated, the advanced setting screen 300B shown in FIG. 3B is displayed by operating the control 302. The advanced setting screen 300B includes controls 305 and 306. The control 305 is a reading spot selector to select and set a reading spot of a document in the scanning apparatus 102, that is, a placement member on which a document to be read is placed. As described above, the scanning apparatus 102 includes the flatbed (a document table glass) and the feeder as the document reading spots. In FIG. 3B, "Flatbed" is selected by the control 305 as an example. The control 306 is a button to complete the setting. Further, when the user operates the control 306, the display content returns to the scan setting screen 300A shown in FIG. 3A.

In the case where the expansion application 204 is associated, the advanced setting screen (a selection screen) 300C shown in FIG. 3C is displayed (a display control step) by operating the control 302. The advanced setting screen 300C is displayed in a first display control step prior to a first transmission step described later. The advanced setting screen 300C is displayed together with the scan setting screen 300A, but its display mode is not particularly limited. For example, the advanced setting screen 300C may be displayed over the scan setting screen 300A, the advanced setting screen 300C may be displayed adjacent to the scan setting screen 300A, or the advanced setting screen 300C may be displayed after the scan setting screen 300A disappears once.

The advanced setting screen 300C includes the controls 305 and 306 as with the advanced setting screen 300B. The advanced setting screen 300C includes a checkbox 307. The checkbox 307 is used to select whether to enable or disable the continuous reading function. For example, when the checkbox 307 is checked as shown in FIG. 3C, the continuous reading function is enabled. On the other hand, when the checkbox 307 is not checked, the continuous reading function is disabled. When the user operates the control 306 in the state where the continuous reading function is enabled by checking the checkbox 307, the display content returns to the scan setting screen 300A. Then, when the user presses the control 303 on the scan setting screen 300A, a first instruction to instruct the scanning apparatus 102 to execute the reading function for a first document on the flatbed can be transmitted (a first transmission step). This enables the scanning apparatus 102 to execute the reading function according to the first instruction.

Here, a reason why the items included in the advanced setting screen 300B shown in FIG. 3B are different from the items included in the advanced setting screen 300C shown in FIG. 3C will be described. That is, the reason why it is possible to switch whether the advanced setting screen 300B is displayed or the advanced setting screen 300C is displayed will be described. The advanced setting screen 300B and the advanced setting screen 300C are generated based on the scan function information (capability information). As described above, the general-purpose scan software 202 does not support the execution of the continuous reading function. Therefore, the continuous reading function cannot be added to the scan function information only by the general-purpose scan software 202.

In addition, even if the continuous reading function is originally included in the scan function information, the general-purpose scan software 202 cannot interpret the continuous reading function included in the scan function information. Therefore, the items about the continuous reading function cannot be displayed on the advanced setting screen. Accordingly, the scan function expansion unit 206 adds the continuous reading function to the scan function information 203. Then, the scan-setting-screen expansion unit 205 refers to the capability information and displays the advanced setting screen 300C. The advanced setting screen 300C allows the setting of the continuous reading function. A setting item for a function other than the continuous reading function may be added to the advanced setting screen 300C.

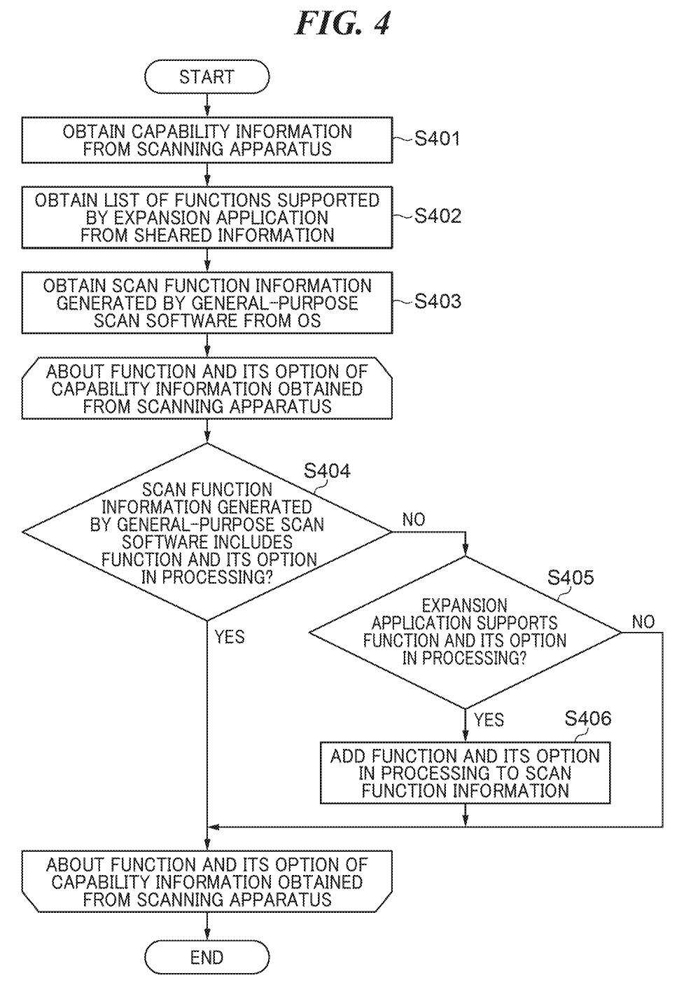

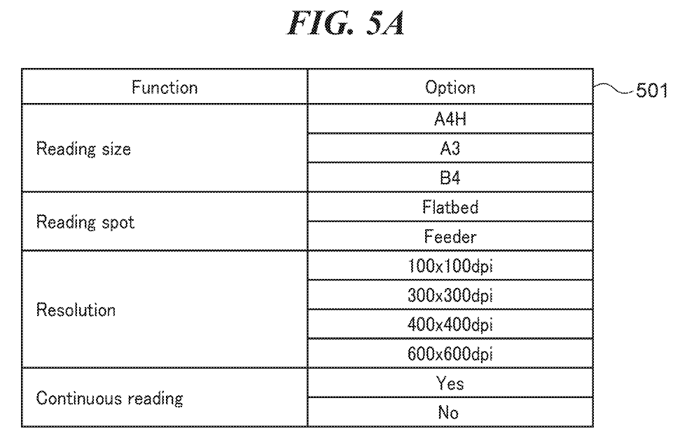

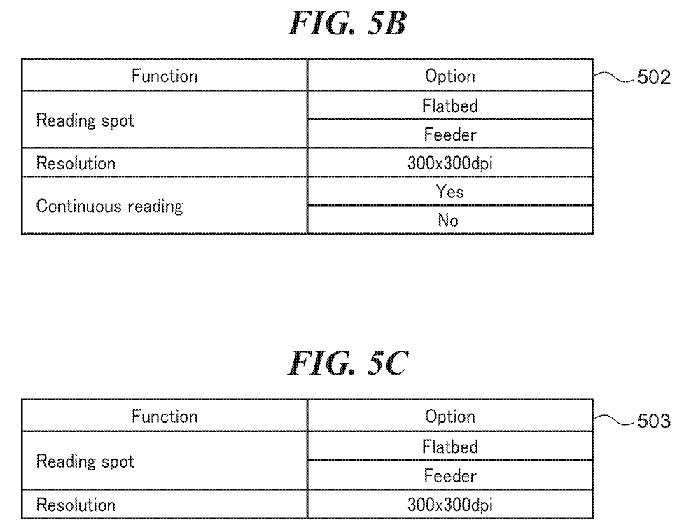

FIG. 4 is a flowchart illustrating a process in which the scan function expansion unit edits the scan function information. Note that a program based on the flowchart shown in FIG. 4 is executed by the CPU 111 controlling the scan function expansion unit 206. FIG. 5A, FIG. 5B, and FIG. 5C are views illustrating examples of lists of the scan information.

As shown in FIG. 4, in a step S401, the scan function expansion unit 206 obtains the capability information from the scanning apparatus 102. The capability information is related to the capability of executing the scan function, and in the present embodiment, includes attribute information indicating a function that can be designated to the scanning apparatus 102 and a set value (an option) related to the attribute information. A table 501 illustrated in FIG. 5A shows a list of the capability information obtained from the scanning apparatus 102. As illustrated in the table 501, for example, a function such as a continuous reading function and its options that can be set for each function can be obtained from the scanning apparatus 102. For example, the options of the continuous reading function include "Yes" indicating that the continuous reading function is executed and "No" indicating that the continuous reading function is not executed.

In a step S402, the scan function expansion unit 206 obtains the scan functions supported by the expansion application 204 from the shared information 208. The shared information 208 stores a list of the scan functions supported by the expansion application 204. A table 502 shown in FIG. 5B includes all the scan functions that can be executed (supported) by the expansion application 204 and set values (options) thereof. For example, the options of the continuous reading function include "Yes" and "No". The scan function that can be executed by the expansion application 204 may be updated by updating the expansion application 204.

In a step S403, the scan function expansion unit 206 obtains the scan function information 203 generated by the general-purpose scan software 202 from the OS. The scan function information 203 is generated on the basis of the capability information obtained by the general-purpose scan software 202 from the scanning apparatus 102. The scan function information 203 generated by the general-purpose scan software 202 includes only a scan function that can be executed by the general-purpose scan software 202 among the capability information obtained from the scanning apparatus 102.

A table 503 shown in FIG. 5C includes all scan functions that can be executed by the general-purpose scan software 202 and their set values (options). As shown in the table 503, the scan functions that can be executed by the general-purpose scan software 202 do not include the continuous reading function. Therefore, the scan function information 203 does not include the continuous reading function. The scan function expansion unit 206 adds a function and an option to the scan function information 203, and thus the expansion application 204 can compensate for a lack of function of the general-purpose scan software 202. The scan function expansion unit 206 can also delete unnecessary functions and options from the scan function information 203 generated by the general-purpose scan software 202.

Steps S404, S405, and S406 are processes that are repeatedly performed on the list of functions included in the capability information obtained from the scanning apparatus 102 in the step S401. In the present embodiment, the steps S404, S405, and S406 are repeated for all 11 options included in the table 501.

In the step S404, the scan function expansion unit 206 determines whether the scan function information 203 generated by the general-purpose scan software 202 includes a function and its option currently processed. As a result of the determination in the step S404, when it is determined that the scan function information 203 includes the function and its option, the process ends if the last item of the options is processed. Alternatively, when the option currently processed is not the last item of the options, the next item of the options is selected and the process from the step S404 is performed again.

On the other hand, when it is determined in the step S404 that the scan function information 203 does not include the function and its option currently processed, the process proceeds to the step S405. For example, in the present embodiment, the table 501 includes the function “Reading spot” and its option “Flatbed”, and the table 503 also includes the function “Reading spot” and its option “Flatbed”. In this case, it is determined in the step S404 that the scan function information 203 includes the function and its option currently processed. In contrast, the table 501 includes the function “Continuous reading” and its option “Yes”, but the table 503 does not include the function “Continuous reading” and its option “Yes”. In this case, it is determined in the step S404 that the scan function information 203 does not include the function and its option currently processed.

In the step S405, the scan function expansion unit 206 determines whether the functions and their options supported by the expansion application 204 include the function and its option currently processed, that is, whether the expansion application 204 supports the function and its option in processing. When it is determined in the step S405 that the expansion application supports the function and its option in processing, the process proceeds to a step S406. On the other hand, when it is determined in the step S405 that the expansion application 204 does not support the function and its option in processing, the process is terminated when the option currently processed is the last item of the options, as in the case where “Yes” is determined in the step S404. Alternatively, when the option currently processed is not the last item of the options, the next item of the options is selected and the process from the step S404 is performed again. For example, in the present embodiment, when the function currently being processed is the “Continuous reading” and its option is “Yes”, the table 502 also includes the function “Continuous reading” and its option “Yes”. Therefore, it is determined in the step S405 that the expansion application 204 support the function and its option in processing.

In the step S406, the scan function expansion unit 206 adds the currently processed function and its option to the scan function information 203. After the step S406 is executed, if the last item in the options is being processed, the process is terminated, as in the case where “Yes” is determined in the step S404. Alternatively, when the option currently processed is not the last item of the options, the next item of the options is selected and the process from the step S404 is performed again.

As described above, the expansion application 204 can add, to the scan function information 203, a function and its option that are not supported by the general-purpose scan software 202, are supported by the scanning apparatus 102, and are supported by the expansion application 204. Then, the capability information is generated based on the scan function information 203 edited by the addition process. The scan-setting-screen expansion unit 205 can display the advanced setting screen 300C shown in FIG. 3C by generating the display screen based on the capability information and expanding the capability to the function that is not supported by the general-purpose scan software 202.

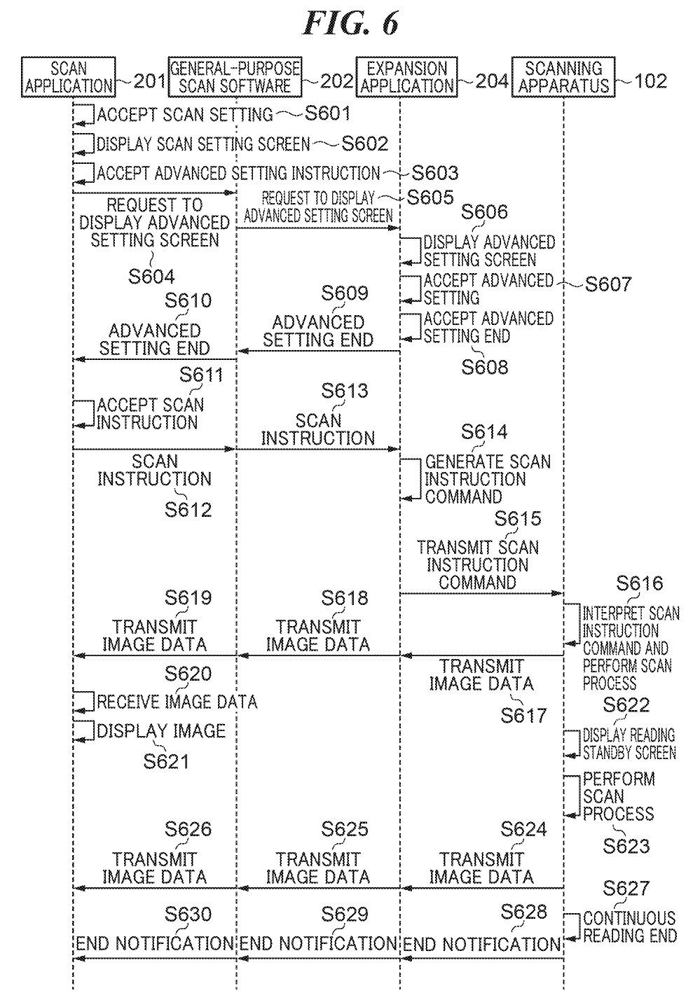

FIG. 6 is a sequence chart illustrating a process executed among the scan application, the general-purpose scan software, the expansion application, and the scanning apparatus after the scan application accepts a scan setting. The processes of the scan application, general-purpose scan software, and expansion application are executed by the CPU 111 of the host computer 101. The process program is stored in the external storage device 114. Then, the CPU 111 reads the process program from the external storage device 114 to the RAM 113 and executes the process program.

The process of the scanning apparatus 102 is executed by the CPU 191 of the scanning apparatus 102. The process program is stored in the external storage device 199. Then, the CPU 191 reads the process program from the external storage device 199 to the RAM 193 and executes the process program. The process in the scanning apparatus 102 may be executed by the CPU 111 via the CPU 191. The scanning system 1000 employs the software configuration shown in FIG. 2B.

As shown in FIG. 6, the scan application 201 accepts a scan setting by a user in a step S601. The user can instruct the scan application 201 to execute the scan setting by operating, for example, the pointing device 117 or the keyboard 118.

In a step S602, the scan application 201 displays the scan setting screen 300A shown in FIG. 3A on the display unit 119.

In a step S603, the scan application 201 receives an advanced setting instruction by the user. The user can instruct the advanced setting by selecting the control 302 on the scan setting screen 300A by operating, for example, the pointing device 117 or the keyboard 118.

In a step S604, the scan application 201 requests the general-purpose scan software 202 to display the advanced setting screen.

In a step S605, the general-purpose scan software 202 requests the expansion application 204 to display the advanced setting screen.

In a step S606, the scan-setting-screen expansion unit 205 of the expansion application 204 displays the advanced setting screen 300C shown in FIG. 3C on the display unit 119 in response to the request in the step S605 (a first display control step). As described above, the scan function expansion unit 206 adds the continuous reading function to the scan function information 203. The scan-setting-screen expansion unit 205 can display the advanced setting screen 300C by referring to the capability information generated based on the scan function information 203 to which the continuous reading function. Note that, for example, when there are setting items, such as resolutions of an image, these setting items may be displayed as necessary, may discontinue displaying, or may be grayed out.

In a step S607, the scan-setting-screen expansion unit 205 accepts the advanced setting on the advanced setting screen 300C by the user. Here, as an example, on the advanced setting screen 300C, the reading spot "Flatbed" is selected in the control 305 and the checkbox 307 is checked, that is, the continuous reading function is set (see FIG. 3C). In this setting state, the scan-setting-screen expansion unit 205 accepts an operation of the control 306 on the advanced setting screen 300C by the user. Accordingly, the CPU 111 stores the setting state on the advanced setting screen 300C in the RAM 113.

In a step S608, the scan-setting-screen expansion unit 205 accepts the end of the advanced setting by the user based on the operation of the control 306 in the step S607. The user can instruct the end of the advanced setting by selecting the control 306 by, for example, operating the pointing device 117 or the keyboard 118. As a result, the setting state on the advanced setting screen 300C is written in the scan function information 203. The information written in the scan function information 203 may include, for example, the information of which displaying is discontinued or grayed out.

In a step S609, the expansion application 204 transmits advanced setting end information indicating the end of the advanced setting in the step S608 to the general-purpose scan software 202.

In a step S610, the general-purpose scan software 202 receives the advanced setting end information transmitted from the expansion application 204 in the step S609. The general-purpose scan software 202 then transmits the advanced setting end information to the scan application 201.

In a step S611, the scan application 201 accepts a scan instruction by the user. The user can issue a scan instruction, that is, a reading instruction to a first document by operating the pointing device 117 or the keyboard 118 to select the control 303 on the scan setting screen 300A (see FIG. 3A).

In a step S612, the scan application 201 issues the scan instruction (first instruction) accepted in the step S611 to the general-purpose scan software 202.

In a step S613, the general-purpose scan software 202 receives the scan instruction issued in the step S612 and transmits the received scan instruction to the expansion application 204.

In a step S614, the expansion application 204 receives the scan instruction transmitted in the step S613. Then, the expansion application 204 generates a scan instruction command on the basis of the scan function information 203 in which the setting state on the advanced setting screen 300C is written. The scan instruction command includes the continuous reading function information received in the advanced setting screen 300C in the step S607. In addition, the information of which displaying is discontinued or grayed out in the step S607 may not be written in the scan function information 203. In this case, the expansion application 204 may add the information that is not written in the scan function information 203 to the scan instruction command or may add a default value.

In a step S615, the expansion application 204 transmits the scan instruction command generated in the step S614 to the scanning apparatus 102.

In a step S616, the input/output interface 198 of the scanning apparatus 102 receives the scan instruction command transmitted in the step S615. Then, the reading unit 195 of the scanning apparatus 102 interprets the scan instruction command and executes scanning under the setting condition in the advanced setting screen 300C. Accordingly, scan image data (read image data) of the first document is obtained.

In a step S617, the input/output interface 198 of the scanning apparatus 102 transmits the image data obtained in the step S616 to the expansion application 204.

In a step S618, the expansion application 204 receives the scan image data transmitted in the step S617 (an obtaining step). Then, the expansion application 204 transmits the scan image data to the general-purpose scan software 202.

In a step S619, the general-purpose scan software 202 receives the scan image data transmitted in the step S618. The general-purpose scan software 202 then transmits the scan image data to the scan application 201.

In a step S620, the scan application 201 receives the scan image data transmitted in the step S619 (the obtaining step).

In a step S621, the scan application 201 displays the image data received in the step S620 on the display unit 119. Accordingly, the scan image data of the first document is displayed on the display unit 119 as a preview image.

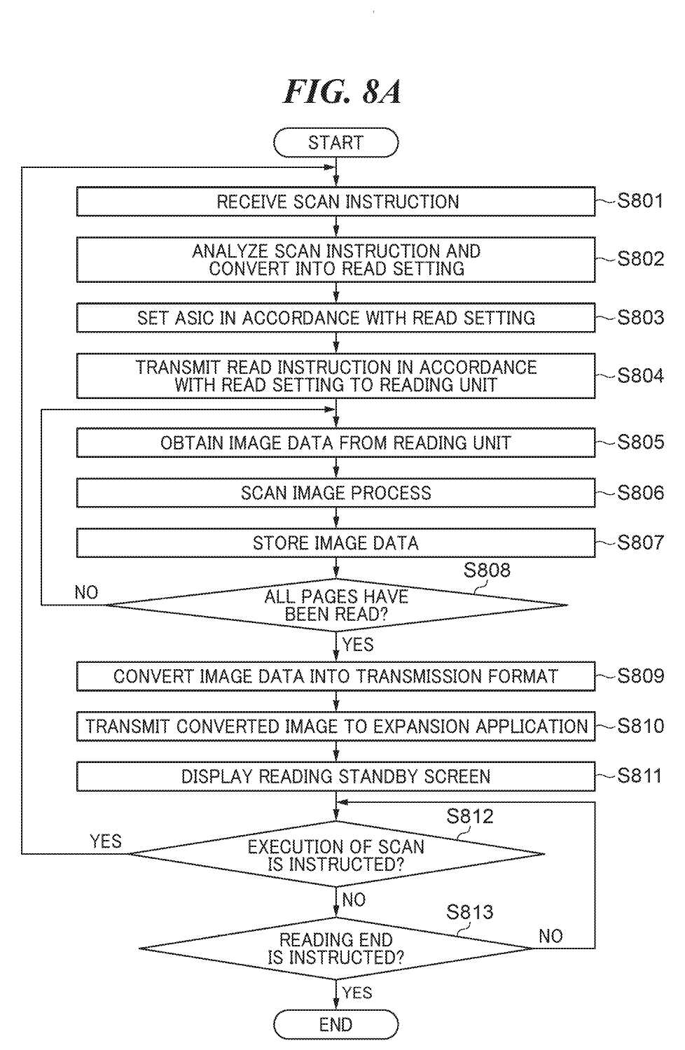

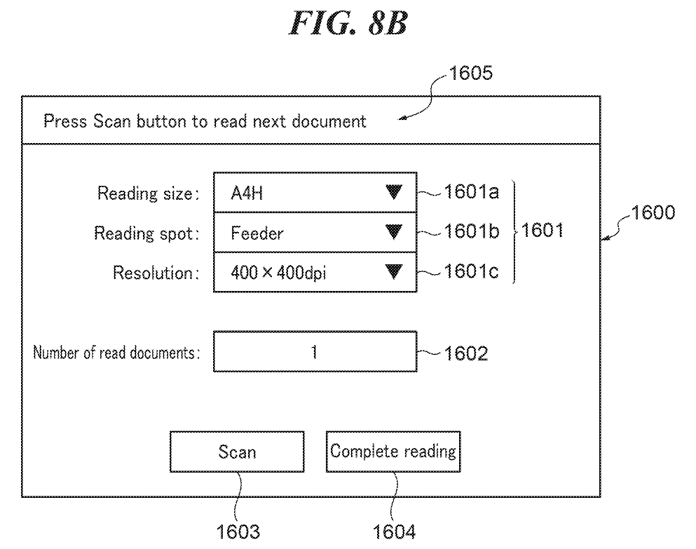

In a step S622, the scanning apparatus 102 is placed on a reading standby state of waiting for an instruction to execute the reading function to a second document placed on the flatbed instead of the first document. At this time, a reading standby screen 1600 (see FIG. 8B) is displayed on the display unit 119 of the host computer 101 (a display control step). This display control step is a second display control step following the first display control step. The reading standby screen 1600 may be displayed on the operation unit 194 of the scanning apparatus 102. The reading standby screen 1600 is a reception screen to receive a second instruction instructing execution of the reading function for the second document.

As described above, the scan function that can be executed by the general-purpose scan software 202 does not include the continuous reading function (see FIG. 5C). Accordingly, the function of displaying the reading standby screen 1600 is a function that cannot be executed by the general-purpose scan software 202, and thus the expansion application 204 is responsible for the function. When the user presses a control 1603 on the reading standby screen 1600, the instruction to read the second document is received. Then, this instruction is transmitted to the scanning apparatus 102 (a second transmission step). The reading standby screen 1600 will be described later with reference to FIG. 8B.

In a step S623, the reading unit 195 of the scanning apparatus 102 executes scanning under the setting condition on the reading standby screen 1600 in response to the second document reading instruction in the step S622. Accordingly, scan image data (read image data) of the second document is obtained.

In a step S624, the input/output interface 198 of the scanning apparatus 102 transmits the image data obtained in the step S623 to the expansion application 204.

In a step S625, the expansion application 204 receives the scan image data transmitted in the step S624. Then, the expansion application 204 transmits the scan image data to the general-purpose scan software 202.

In a step S626, the general-purpose scan software 202 receives the scan image data transmitted in the step S625. The general-purpose scan software 202 then transmits the scan image data to the scan application 201. The scan application 201 receives the scan image data (the obtaining step). After receiving the scan image data, the scan application 201 may display the image data on the display unit 119. Accordingly, the scan image data of the second document is displayed on the display unit 119 as a preview image.

In a step S627, the scanning apparatus 102 is placed on a reading standby state as in the step S622. At this time, the reading standby screen 1600 is displayed again. When the user presses a control 1604 on the reading standby screen 1600, the instruction to read the document following the document reading in the step S623 is canceled, the continuous reading ends, and the display of the reading standby screen 1600 is discontinued.

In a step S628, the input/output interface 198 of the scanning apparatus 102 notifies the expansion application 204 that the continuous reading ends in the step S627.

In a step S629, the expansion application 204 receives the continuous reading end notified in the step S628. Then, the expansion application 204 notifies the general-purpose scan software 202 of the end of the continuous reading.

In a step S630, the general-purpose scan software 202 receives the continuous reading end notified in the step S629. Then, the general-purpose scan software 202 transmits the continuous reading end to the scan application 201. The CPU 111 of the host computer 101 generates one image file including the scan image data (first image data) of the first document and the scan image data (second image data) of the second document that have been obtained (a generation step). Thus, the image file including the images of the first document and the second document by the continuous reading is obtained. The image file is stored in, for example, the external storage device 114. Although the first image data and the second image data are transmitted from the scanning apparatus 102 to the host computer 101, and one image file including these two image data is generated in the host computer 101 in the present embodiment, this is not limited. For example, one image file including the first image data and the second image data may be generated in the scanning apparatus 102 without transmitting these two image data to the host computer 101.

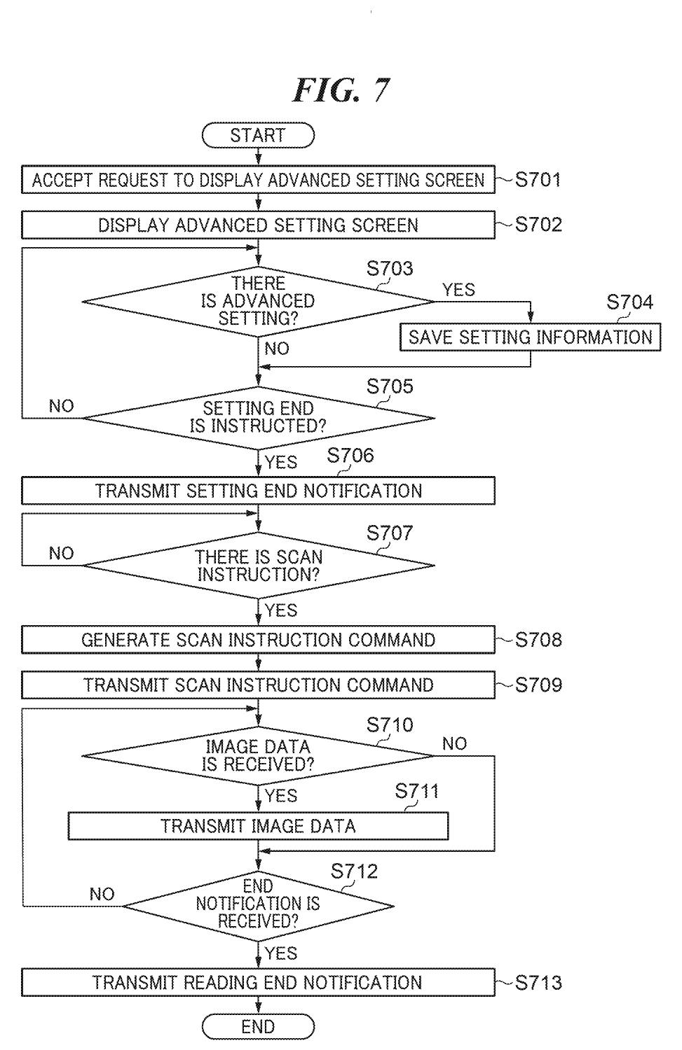

FIG. 7 is a flowchart illustrating a process executed by the expansion application. A program based on the flowchart shown in FIG. 7 is stored in the external storage device 114. The CPU 111 can execute the program by reading it from the external storage device 114 to the RAM 113. As illustrated in FIG. 7, the expansion application 204 accepts a display request (see the step S605) of the advanced setting screen from the general-purpose scan software 202 in a step S701.

In a step S702, the scan-setting-screen expansion unit 205 of the expansion application 204 displays the advanced setting screen 300C shown in FIG. 3C on the display unit 119 in response to the advanced setting display request received in the step S701. As described above, the continuous reading function is added to the scan function information 203. The scan-setting-screen expansion unit 205 can display the advanced setting screen 300C with reference to the capability information generated based on the scan function information 203.

In a step S703, the scan-setting-screen expansion unit 205 determines whether the advanced setting is set on the advanced setting screen 300C, that is, whether there are selection of the control 305 and the check of the checkbox 307. As a result of the determination in the step S703, when it is determined that the advanced setting is set, the process proceeds to a step S704. On the other hand, when it is determined in the step S703 that the advanced setting is not set, the process proceeds to a step S705.

In the step S704, the scan-setting-screen expansion unit 205 stores (saves) the setting state (setting information) on the advanced setting screen 300C in the RAM 113. After the process in the step S704 is executed, the process proceeds to the step S705.

In the step S705, the scan-setting-screen expansion unit 205 determines whether an advanced setting end is instructed on the advanced setting screen 300C, that is, whether the control 306 is operated. As a result of the determination in the step S705, when it is determined that the advanced setting end is instructed, the process proceeds to a step S706. On the other hand, as a result of the determination in the step S705, when it is determined that the advanced setting end is not instructed, the process returns to the step S703, and the subsequent steps are sequentially executed.

In the step S706, the expansion application 204 notifies the general-purpose scan software 202 of the advanced setting end determined in the step S705, that is, transmits a setting end notification.

In a step S707, the expansion application 204 determines whether there is a scan instruction (see the step S613) from the general-purpose scan software 202. As a result of the determination in the step S707, when it is determined that there is a scan instruction, the process proceeds to a step S708. On the other hand, as a result of the determination in the step S707, when it is determined that there is no scan instruction, the process waits in the step S707.

In the step S708, the expansion application 204 generates a scan instruction command on the basis of the scan function information 203 in which the setting state on the advanced setting screen 300C is written. The scan instruction command is generated by a method of expanding a function of a command conforming to a standard protocol. This expansion method describes a dedicated command in an expansion area of the command of the standard protocol. Other extension methods include a method of adding a command of a unique standard to the end of the commands of the standard protocol, a method of overwriting a command of the standard protocol with a command system unique to the expansion application 204. In addition, in a case where the expansion application 204 issues an instruction, the instruction and communication may be performed by a protocol unique to a manufacturer regardless of the standard protocol.

In a step S709, the expansion application 204 transmits the scan instruction command generated in the step S708 to the scanning apparatus 102.

In a step S710, the expansion application 204 determines whether all the scan image data have been received from the scanning apparatus 102 (see the steps S617 and S624). As a result of the determination in the step S710. when it is determined that all the data has been received, the process proceeds to a step S711. On the other hand, as a result of the determination in the step S710, when it is determined that not all the data have been received, the process proceeds to a step S712.

In the step S711, the expansion application 204 transmits all the scan image data that are received from scanning apparatus 102 and determined in the step S710 to the general-purpose scan software 202.

In the step S712, the expansion application 204 determines whether the continuous reading end (see the step S628) from the scanning apparatus 102 is received. As a result of the determination in the step S712, when it is determined that the continuous reading end is received, the process proceeds to a step S713. On the other hand, as a result of the determination in the step S712, when it is determined that the continuous reading end is not received, the process returns to the step S710, and the subsequent steps are executed in order.

In the step S713, the expansion application 204 notifies the general-purpose scan software 202 of the end of the continuous reading, that is, transmits a reading end notification (see the step S629), and then the process ends.

FIG. 8A is a flowchart illustrating a process executed in the scanning apparatus. A program based on the flowchart shown in FIG. 8A is stored in the external storage device 199. The CPU 191 can execute the program by reading it from the external storage device 199 to the RAM 193. As shown in FIG. 8A, in a step S801, the CPU 191 receives the scan instruction command (see the step S615) from the expansion application 204.

In a step S802, the CPU 191 interprets the scan instruction command received in the step S801. Then, the CPU 191 converts the scan instruction command into a read setting that enables the scan process in the scanning apparatus 102 under the setting condition set on the advanced setting screen 300C, that is, enables the scan process with the continuous reading function using the flatbed.

In a step S803, the CPU 191 decides an ASIC of the image processor 190 to be used to execute scanning in accordance with the setting (read setting) converted in the step S802, and sets up the ASIC.

In a step S804, the CPU 191 transmits a read instruction in accordance with the read setting to the reading unit 195.

In a step S805, the CPU 191 obtains the scan image data from the reading unit 195.

In a step S806, the CPU 191 controls the image processor 190 to perform an image process on the scan image data obtained in the step S805.

In a step S807, the CPU 191 stores the scan image data obtained in the step S806 in the external storage device 199.

In a step S808, the CPU 191 determines whether the scan process has been completed for all pages of the reading target document. As a result of the determination in the step S808, it is determined that the scan process is completed, the process proceeds to a step S809. On the other hand, as a result of the determination in the step S808, when it is determined that the scan process is completed, the process returns to the step S805, and the subsequent steps are sequentially executed.

In the step S809, the CPU 191 controls the image processor 190 to convert the scan image data stored in the step S807 in accordance with to a transmission format. In the present embodiment, the transmission format is not included in the scan instruction command received in the step S801. Therefore, the scan image data is converted into the JPEG format that is a default format of the scanning apparatus 102, but this is not limited.

In a step S810, the CPU 191 controls the input/output interface 198 to transmit the scan image data converted in the step S809 to the expansion application 204.

In a step S811, the CPU 191 displays the reading standby screen 1600 (see FIG. 8B) on the display unit 119.

In a step S812, the CPU 191 determines whether the execution of scanning is instructed to the reading unit 195 of the scanning apparatus 102 by determining whether the control 1603 on the reading standby screen 1600 is pressed (see the step S623). As a result of the determination in the step S812, when it is determined that the control 1603 is pressed, the process returns to the step S801, and the subsequent steps are executed in order. On the other hand, as a result of the determination in the step S801, when it is determined that the control 1603 is not pressed, the process proceeds to a step S813.

In the step S813, the CPU 191 determines whether reading end is instructed by determining whether the control 1604, which is a button to instruct the reading end to the reading unit of the scanning apparatus 102, on the reading standby screen 1600 is pressed (see the step S627). Then, as a result of the determination in the step S813, when it is determined that the control 1604 is pressed, the process ends. On the other hand, as a result of the determination in the step S813, when it is determined that the control 1604 is not pressed, the process returns to the step S812, and the subsequent steps are sequentially executed.

Although the present embodiment describes the case where the continuous reading is performed using the flatbed, the continuous reading may be performed using the feeder. In addition, when there are a plurality of image data, all the image data are transmitted to the expansion application 204 after all the image data are received in the present embodiment, but this is not limited. For example, each image data may be transmitted to the expansion application 204 each time after being received.

As described above, even when the general-purpose scan software 202 in the scanning system 1000 does not support the continuous reading function, the expansion application 204 can execute the continuous reading function. Accordingly, the scanning apparatus 102 can perform scanning in the state where the continuous reading function is set. That is, when documents are divided into a plurality of document bundles and are read at a plurality of times, the reading standby screen 1600 is displayed whenever the reading of each document bundle is completed, and an instruction to read an unread document bundle can be issued.

In the description referring to FIG. 6, the advanced setting screen 300C shown in FIG. 3C is displayed assuming that the scanning system 1000 employs the software configuration shown in FIG. 2B, but this is not limited. For example, when receiving a display request of an advanced setting screen in the step S604, the general-purpose scan software 202 displays the advanced setting screen 300B shown in FIG. 3B. In this case, after the user operates the control 306 on the advanced setting screen 300B, the general-purpose scan software 202 requests the expansion application 204 to display an additional advanced setting screen. Next, the expansion application 204 may additionally display an advanced setting screen in which the continuous reading function can be set.

Further, the scan instruction is transmitted from the general-purpose scan software 202 to the expansion application 204 in the step S613, but this is not limited. For example, the scan application 201 may issue the scan instruction to the expansion application 204. A scan instruction control may be arranged on the advanced setting screen 300C. In this case, the scan application 201 issues the scan instruction to the expansion application 204 when the user operates the scan instruction control.

Further, the scan image data may be transmitted from the scanning apparatus 102 to the scan application 201 via the expansion application 204 without passing through the general-purpose scan software 202. The scan image data may also be directly transmitted from the scanning apparatus 102 to the scan application 201. The scan system 1000 may be configured to store the scan image data in the external storage device 114 and to transfer only information about a file path of a storage destination. In the scanning system 1000, when there are a plurality of scan image data, all the scan image data may be transmitted at once, or may be transmitted whenever the scan image data is obtained.

FIG. 8B is a view illustrating an example of a screen displayed on the display unit of the scan system. The reading standby screen 1600 illustrated in FIG. 8B is a screen for instructing execution of a further reading function following the execution of the reading function in the continuous reading. The reading standby screen 1600 includes controls 1601, 1602, 1603, and 1604, and a message 1605. The control 1601 allows the user to set reading conditions. In the present embodiment, the control 1601 includes sub-controls 1601a, 1601b, and 1601c. The sub-control 1601a is a reading size setting part in which a reading size of a document to be read is set. In FIG. 8B, as an example, "A4H" is set as the reading size. The sub-control 1601b is a reading spot selector in which the flatbed or the feeder is selected as the reading spot (a placement member) on which a document to be read is placed. In FIG. 8B, as an example, the "Feeder" is selected as the reading spot. The sub-control 1601c is a resolution setting part in which a resolution for reading a document is set. In FIG. 8B, a resolution of "400 × 400dpi" is set, as an example. The execution conditions of the further reading function can be changed as appropriate by operating the sub-controls 1601a, 1601b, and 1601c.

In a control (a number-of-documents display part) 1602, the number of documents read by the execution of the further reading function can be displayed. In FIG. 8B, "1" is displayed as the number of read documents as an example. This allows the user to understand the number of read documents. Although the reading standby screen 1600 includes the sub-controls 1601a, 1601b, and 1601c, and the control 1602 in the present embodiment, this is not limited, and at least one of these controls may be included. The control 1603 allows the user to instruct the start of scanning by the scanning apparatus 102. The control 1604 allows the user to instruct cancellation of the scanning by the scanning apparatus 102. The message 1605 indicates that the further reading function can be executed. The reading standby screen 1600 improves operability when the continuous reading is instructed.

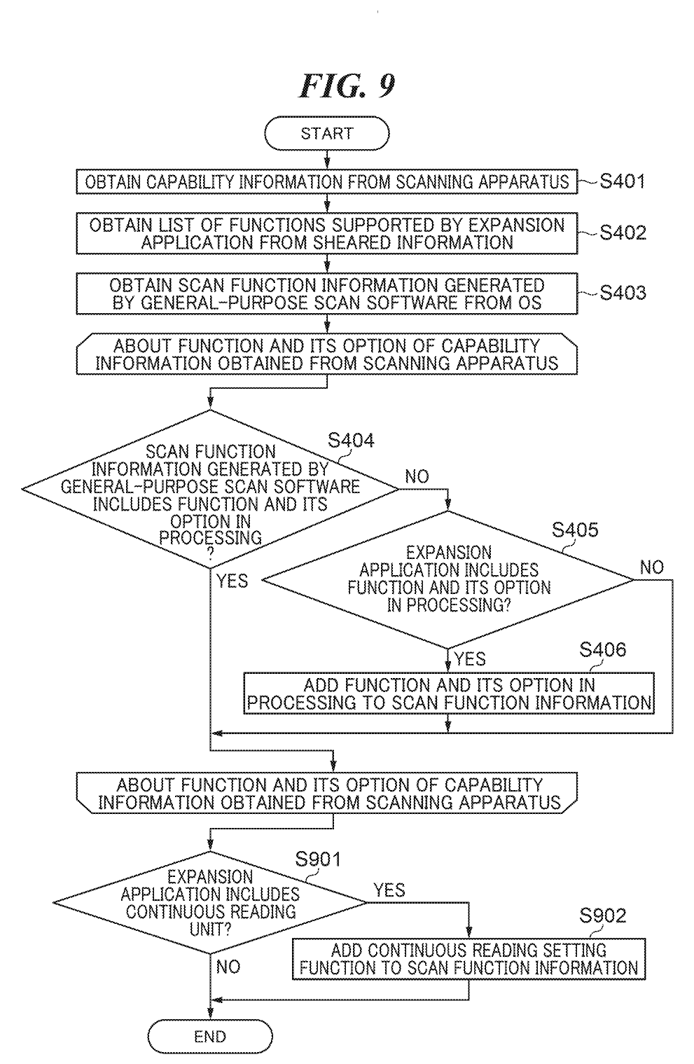

Hereinafter, a second embodiment will be described with reference to FIG. 9 to FIG. 11. Differences from the above-described embodiment will be mainly described, and the description of the same matters will be omitted. In first embodiment, the expansion application 204 performs the setting of the continuous reading function together with the general-purpose scan software 202. Then, the scanning apparatus 102 is instructed to execute the continuous reading according to this setting. Accordingly, the scanning apparatus 102 can execute the continuous reading. In this manner, in the first embodiment, the expansion application 204 causes the scanning apparatus 102 to execute the continuous reading together with the general-purpose scan software 202.

However, some scanning apparatuses cannot execute the continuous reading. In this case, even if the expansion application 204 instructs to execute the continuous reading, the scanning apparatus 102 cannot perform the continuous reading. In the present embodiment, it is determined whether the scanning apparatus can execute the continuous reading on the basis of the capability information of the scanning apparatus 102. As a result of this determination, when it is determined that the scanning apparatus can execute the continuous reading, the scanning apparatus 102 is controlled to execute the continuous reading.

On the other hand, when it is determined that the scanning apparatus 102 cannot execute the continuous reading, the scanning apparatus 102 is controlled to execute normal reading by the number of times of the continuous reading. This provides the continuous reading to the user even if the scanning apparatus 102 cannot execute the continuous reading. In this embodiment, the scan function expansion unit 206 is different from it in the first embodiment. Specifically, when the capability information of the scanning apparatus 102 does not include the information related to the continuous reading, the scan function expansion unit 206 adds the continuous reading function to the scan function information 203 when the expansion application 204 has a unit capable of executing the generation process. For example, the image data editing unit 207 performs the generating step on the basis of the continuous reading function.

FIG. 9 is a flowchart illustrating a process in which a scan function expansion unit in the second embodiment edits the scan function information. Note that a program based on the flowchart shown in FIG. 9 is executed by the CPU 111 controlling the scan function expansion unit 206. In addition, the flowchart shown in FIG. 9 is configured by adding a step S901 and a step S902 to the flowchart shown in FIG. 4. As shown in FIG. 9, when the repetitive process from the step S404 to the step S406 is completed, the process proceeds to the step S901. As described above, the capability information of the scanning apparatus 102 does not include information related to the continuous reading. Therefore, the continuous reading function is not added to the scan function information 203 at the time when the process from the step S404 to the step S406 is completed.

As shown in FIG. 9, in the step S901, the scan function expansion unit 206 determines whether the expansion application 204 includes a continuous reading unit having the continuous reading function. As a result of the determination in the step S901, when it is determined that the continuous reading unit is included, the process proceeds to the step S902. On the other hand, as a result of the determination in the step S901, when it is determined that the continuous reading unit is not included, the process ends. In the present embodiment, the expansion application 204 has the continuous reading function. Therefore, it is determined in the step S901 that the continuous reading unit is included, and the process proceeds to the step S902.

In the step S902, the scan function expansion unit 206 adds the information related to the continuous reading (the continuous reading function) to the scan function information 203.

As described above, the expansion application 204 is able to add, to the scan function information 203, a function that is not supported by the general-purpose scan software 202, is supported by the scanning apparatus 102, and is supported by the expansion application 204. Then, the expansion application 204 determines whether the continuous reading function is present. As a result of this determination, when it is determined that the continuous reading function is present, the continuous reading function is added to the scan function information 203. This addition process enables generation of the capability information based on the scan function information 203 to which the continuous reading function is added, even when the scanning apparatus 102 is not capable of executing the continuous reading. The expansion application 204 can display the advanced setting screen 300C shown in FIG. 3C by generating a display screen on the basis of the capability information.

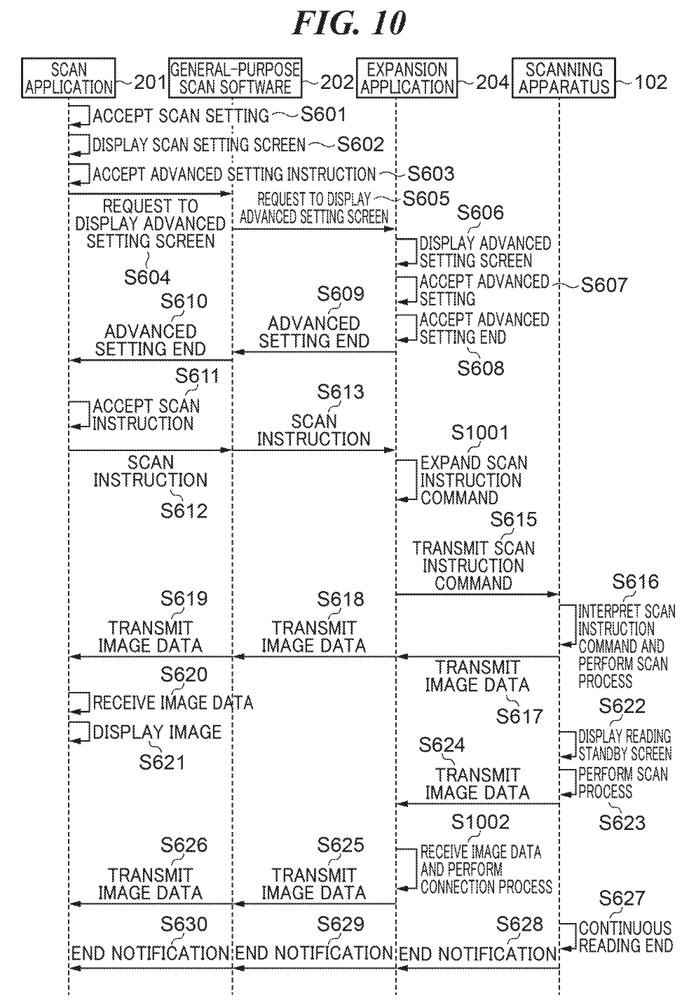

FIG. 10 is a sequence chart illustrating a process executed among the scan application, the general-purpose scan software, the expansion application, and the scanning apparatus after the scan application accepts a scan setting. The sequence chart shown in FIG. 10 is configured on the basis of the sequence chart shown in FIG. 6 by replacing the step S614 with a step S1001 and inserting a step S1002 between the step S624 and the step S625. As shown in FIG. 10, in the step S1001, the expansion application 204 generates a scan instruction command on the basis of the scan function information 203 in which the setting state on the advanced setting screen 300C is written in the step S607.

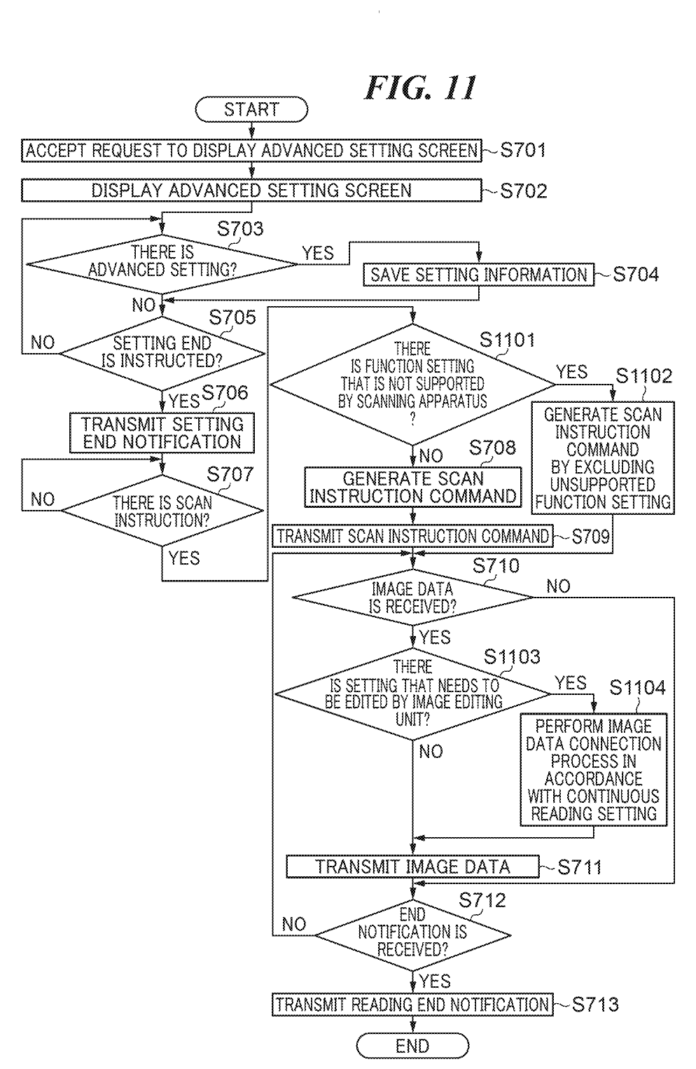

In the step S1002, the expansion application 204 receives the scan image data transmitted in the step S624. Then, the image data editing unit 207 of the expansion application 204 executes a connection process of connecting this image data and the image data obtained in the step S620 to generate one image file including these image data. As a result, the image file including a series of images obtained by the continuous reading is obtained. Details of the step S1001 and the step S1002 will be described later with reference to FIG. 11.

FIG. 11 is a flowchart illustrating the process executed by the expansion application. The flowchart shown in FIG. 11 is configured on the basis of the flowchart shown in FIG. 7. A step S1101 is inserted between the step S707 and the step S708 and a step S1103 is inserted between the step S710 and the step S711. Further, steps S1102 and S1104 are added. As illustrated in FIG. 11, in the step S1101, the expansion application 204 determines whether there is a function setting that is not supported by the scanning apparatus 102, that is, an inexecutable function setting, on the basis of the capability information and the advanced setting information. The capability information of the scanning apparatus 102 is obtained from the shared information 208. In a case where the capability information of the scanning apparatus 102 is not stored in the shared information 208, the scan function expansion unit 206 may request the scanning apparatus 102 to transmit the capability information of the scanning apparatus 102 and store the capability information in the shared information 208. Accordingly, the capability information of the scanning apparatus 102 can be obtained from the shared information 208.

As a result of the determination in the step S1101, when it is determined that there is a function setting that is not supported, the process proceeds to the step S1102. On the other hand, If it is determined in the step S1101 that there is no unsupported function setting, the process proceeds to the step S708. In the present embodiment, the continuous reading that is not supported by the scanning apparatus 102 is set. Therefore, it is determined in the step S1101 that there is a function setting that is not supported and the process proceeds to the step S1102.

In the step S1102, the expansion application 204 generates a scan instruction command by excluding the unsupported function setting that is not supported by the scanning apparatus 102. In the present embodiment, the continuous reading function is not included in the scan instruction command. After the step S1102 is executed, the process proceeds to the step S710.

In the step S1103, the expansion application 204 determines whether there is a setting that needs to be edited by the image data editing unit 207 on the basis of the advanced setting information. As a result of the determination in the step S1103, when it is determined that there is a setting that needs to be edited, the process proceeds to the

step S1104. On the other hand, when it is determined in the step S1103 that there is no setting that needs to be edited, the process proceeds to the step S711. In the present embodiment, since the continuous reading that is not supported by the scanning apparatus 102 is set, it is determined in the step S1103 that there is a setting that needs to be edited.

In the step S1104, the image data editing unit 207 of the expansion application 204 executes an image data connection process of connecting the two obtained image data in accordance with the setting of the continuous reading function determined in the step S703. As a result, one image file including the two image data is generated. After the step S1104 is executed, the process proceeds to the step S711.

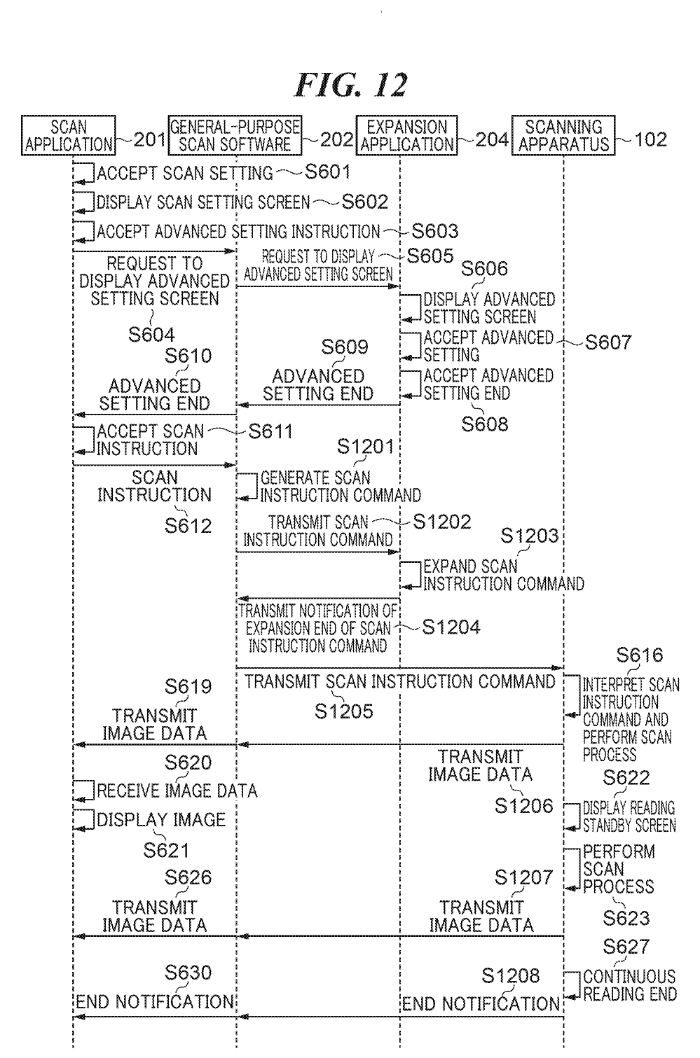

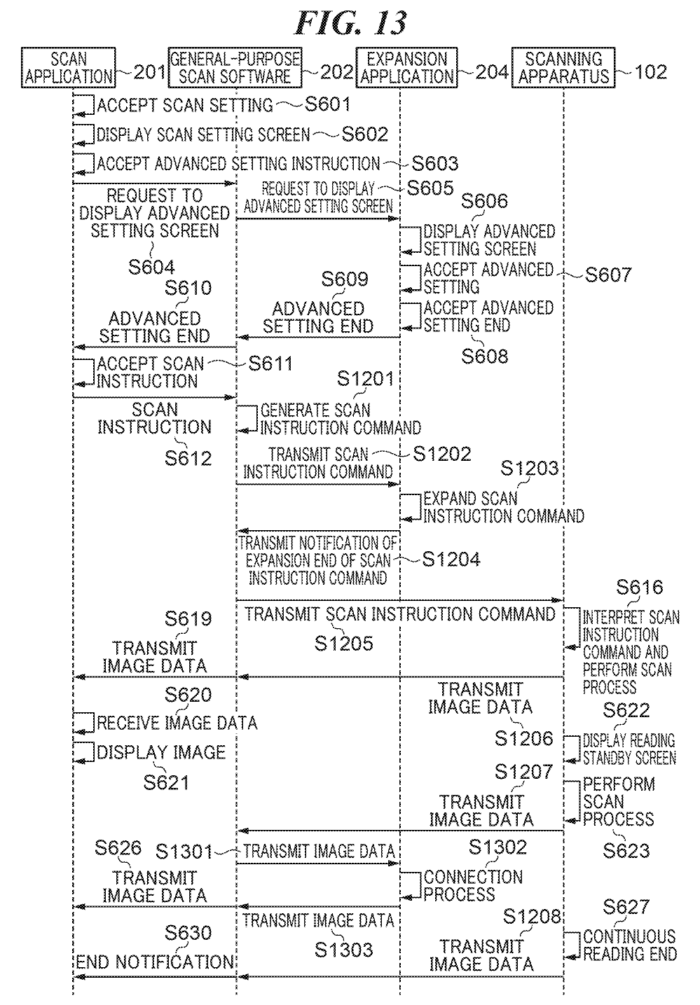

Hereinafter, a third embodiment will be described with reference to FIG. 12 and FIG. 13. Differences from the above-described embodiment will be mainly described, and the description of the same matters will be omitted. In the first embodiment, the information is transmitted and received between the expansion application 204 and the scanning apparatus 102. In the present embodiment, the information is transmitted and received between the scanning apparatus 102 and the general-purpose scan software 202 instead of the expansion application 204. The expansion application 204 expands a scan instruction command and edits an image.

FIG. 12 is a sequence chart illustrating a process executed among the scan application, the general-purpose scan software, the expansion application, and the scanning apparatus in the third embodiment after the scan application accepts a scan setting. The sequence chart shown in FIG. 12 is configured on the basis of the sequence chart shown in FIG. 6 by replacing the steps S613 to S615 with steps S1201 to S1205, replacing the steps S617 and S618 with a step S1206, replacing the steps S624 and S625 with a step S1207, and replacing the steps S628 and S629 with a step S1208.

As illustrated in FIG. 12, in the step S1201, the general-purpose scan software 202 generates a scan instruction command on the basis of the scan instruction received in the step S612. The scan instruction command does not include a function that is not supported by the general-purpose scan software 202.

In the step S1202, the general-purpose scan software 202 transmits the scan instruction command generated in the step S1201 to the expansion application 204.

In the step S1203, the expansion application 204 receives the scan instruction command transmitted in the step S1202 and expands the scan instruction command by adding an instruction command of a function that is not supported by the general-purpose scan software 202 to the scan instruction command or changes an existing instruction in the scan instruction command. In the present embodiment, since the setting of the continuous reading function is not included in the scan instruction command generated in the step S1201, the setting of the continuous reading is added in the step S1203.

In the step S1204, the expansion application 204 notifies the general-purpose scan software 202 of the end of the expansion of the scan instruction command in the step S1203, and transmits the scan instruction command expanded in the step S1203.

In the step S1205, the general-purpose scan software 202 receives the expanded scan instruction command transmitted in the step S1204 and transmits the expanded scan instruction command to the scanning apparatus 102 (transmission of a first instruction). Thus, the scanning is executed in the step S616.

In the step S1206, the input/output interface 198 of the scanning apparatus 102 transmits the image data obtained in the step S616 to the general-purpose scan software 202.

In the step S1207, the input/output interface 198 of the scanning apparatus 102 transmits the image data obtained in the step S623 to the general-purpose scan software 202.

In the step S1208, the input/output interface 198 of the scanning apparatus 102 notifies the general-purpose scan software 202 that the continuous reading ends in the step S627. Although the first instruction is transmitted via the general-purpose scan software 202 in the present embodiment, this is not limited. For example, the first instruction and the second instruction may be transmitted via the general-purpose scan software 202, or only the second instruction may be transmitted via the general-purpose scan software 202.

FIG. 13 is a sequence chart illustrating a process executed among the scan application, the general-purpose scan software, the expansion application, and the scanning apparatus in a variation example of the third embodiment after the scan application accepts a scan setting. The sequence chart shown in FIG. 13 is configured on the basis of the sequence chart shown in FIG. 12 by inserting steps S1301 to S1303 between the steps S1207 and S626. As illustrated in FIG. 13, in the step S1301, the general-purpose scan software 202 receives the image data transmitted in the step S1207 and transmits the received image data to the expansion application 204.

In the step S1302, the expansion application 204 receives the image data transmitted in the step S1301 and edits the received image data. This editing is an image data connection process similar to the step S1104 (see FIG. 11). As a result, one image file is generated.

In the step S1303, the expansion application 204 transmits the image data edited in the step S1302, i.e., one image file, to the general-purpose scan software 202.

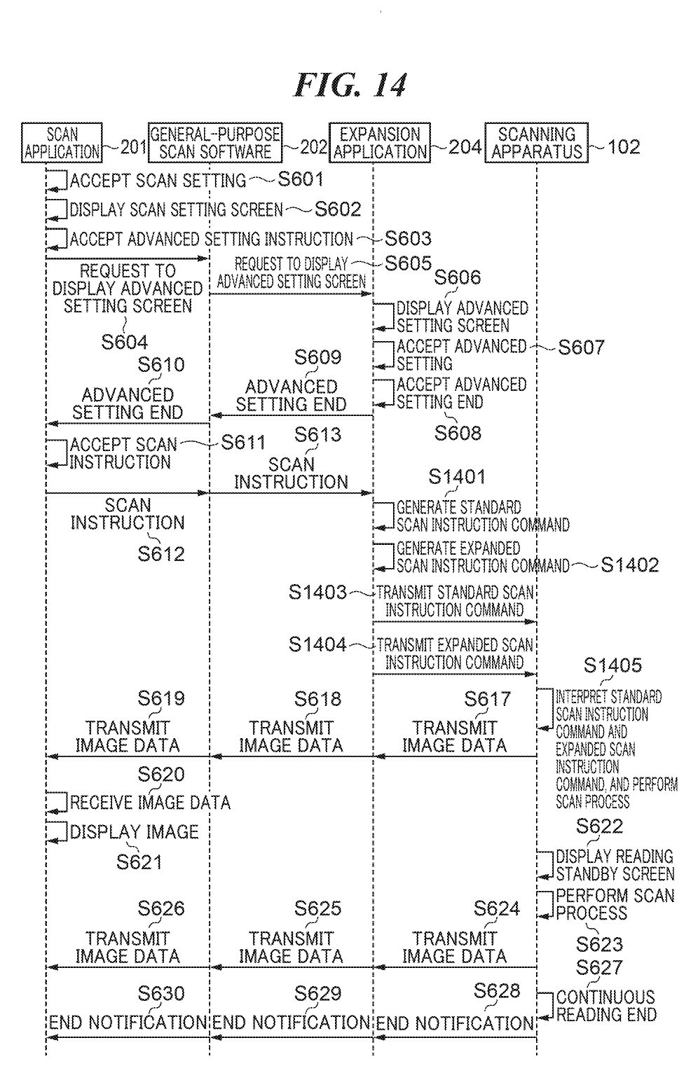

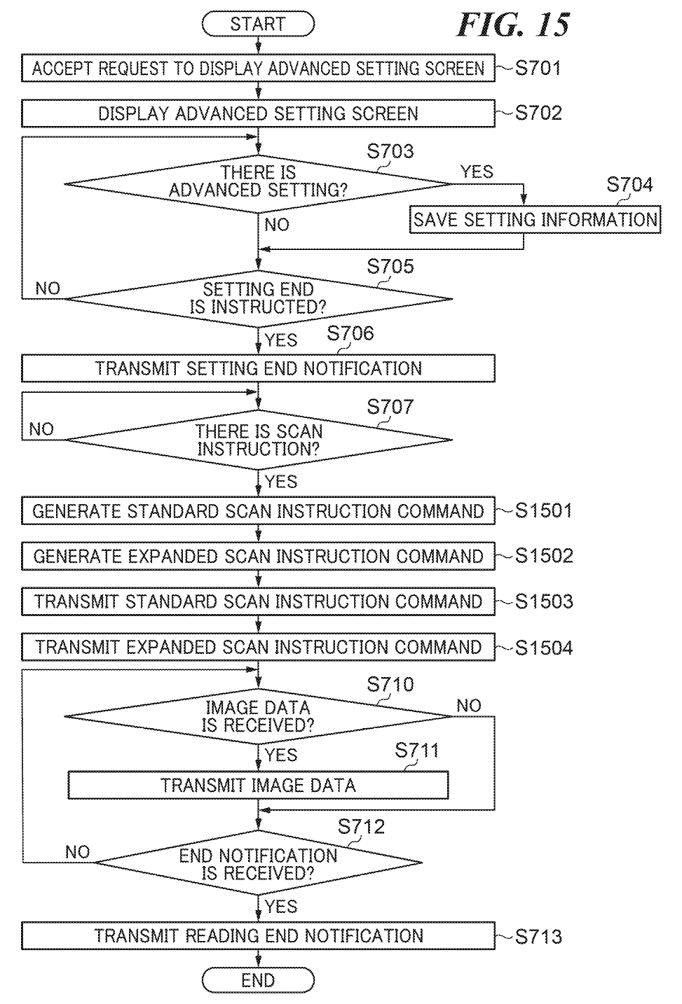

Hereinafter, a fourth embodiment will be described with reference to FIG. 14 and FIG. 15. The description will focus on differences from the above-described embodiments, and the description of the same matters will be omitted. In the first embodiment, a command used in the standard protocol is expanded, and the information is transmitted and received to and from the scanning apparatus 102. In this embodiment, a command used in the standard protocol is not expanded. In addition, a function supported only by the expansion application 204 is achieved by a special command that is not used in the standard protocol. For example, information is transmitted and received to and from the scanning apparatus 102 using the special command.

FIG. 14 is a sequence chart illustrating a process executed among the scan application, the general-purpose scan software, the expansion application, and the scanning apparatus in the fourth embodiment after the scan application accepts a scan setting. The sequence chart shown in FIG. 14 is configured by replacing the steps S614 to S616 in the sequence chart shown in FIG. 6 with steps S1401 to S1405.

As illustrated by FIG. 14, in the step S1401, the expansion application 204 receives the scan instruction transmitted in the step S613 and generates a standard scan instruction command based on the standard protocol. The standard scan instruction command does not include a function that is not supported by the standard protocol.

In the step S1402, the expansion application 204 generates an expanded scan instruction command for a function supported only by the expansion application 204.

In the step S1403, the expansion application 204 transmits the standard scan instruction command generated in the step S1401 to the scanning apparatus 102.

In the step S1404, the expansion application 204 transmits the expanded scan instruction command generated in the step S1402 to the scanning apparatus 102.

In the step S1405, the input/output interface 198 of the scanning apparatus 102 receives the standard scan instruction command transmitted in the step S1403 and the expanded scan instruction command transmitted in the step S1404, and the reading unit 195 of the scanning apparatus 102 interprets the standard scan instruction command and the expanded scan instruction command and performs the scan process.

As described above, in the present embodiment, the standard scan instruction command is not expanded to the continuous reading function supported only by the expansion application 204, and the continuous reading function can be supported by the separate (expanded) scan instruction command. Accordingly, the scanning apparatus 102 can perform scanning in the state where the continuous reading function is set. The execution order of the steps S1401 to S1404 may be changed. For example, these steps may be performed in the order of S1401, S1403, S1402, and S1404.

FIG. 15 is a flowchart illustrating the process executed by the expansion application. The flowchart illustrated in FIG. 15 is configured on the basis of the flowchart illustrated in FIG. 7 by replacing the steps S708 and S709 with steps S1501 to S1504. As illustrated in FIG. 15, in the step S1501, the expansion application 204 generates the standard scan instruction command based on the standard protocol. The step S1501 corresponds to the step S1401 in FIG. 14.

In the step S1502, the expansion application 204 generates the expanded scan instruction command for a function that is not supported by the standard protocol and is supported only by the expansion application 204. The step S1502 corresponds to the step S1402 in FIG. 14.

In the step S1503, the expansion application 204 transmits the standard scan instruction command generated in the step S1501 to the scanning apparatus 102. The step S1503 corresponds to the step S1403 in FIG. 14.

In the step S1504, the expansion application 204 transmits the extended scan instruction command generated in the step S1502 to the scanning apparatus 102. The step S1504 corresponds to the step S1404 in FIG. 14. After the step S1504 is executed, the process proceeds to the step S710.

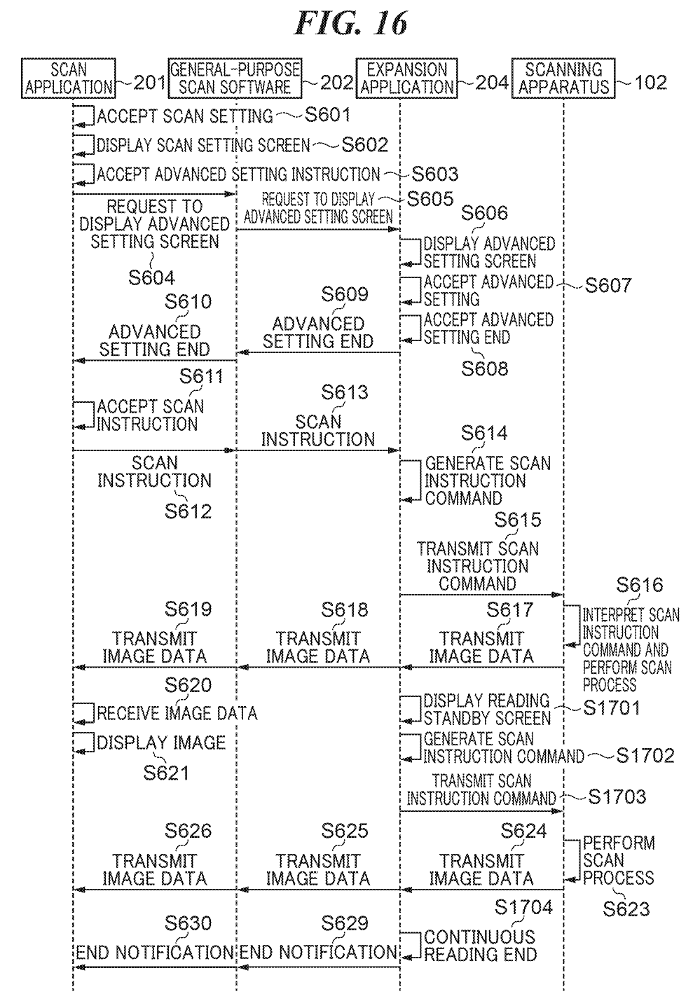

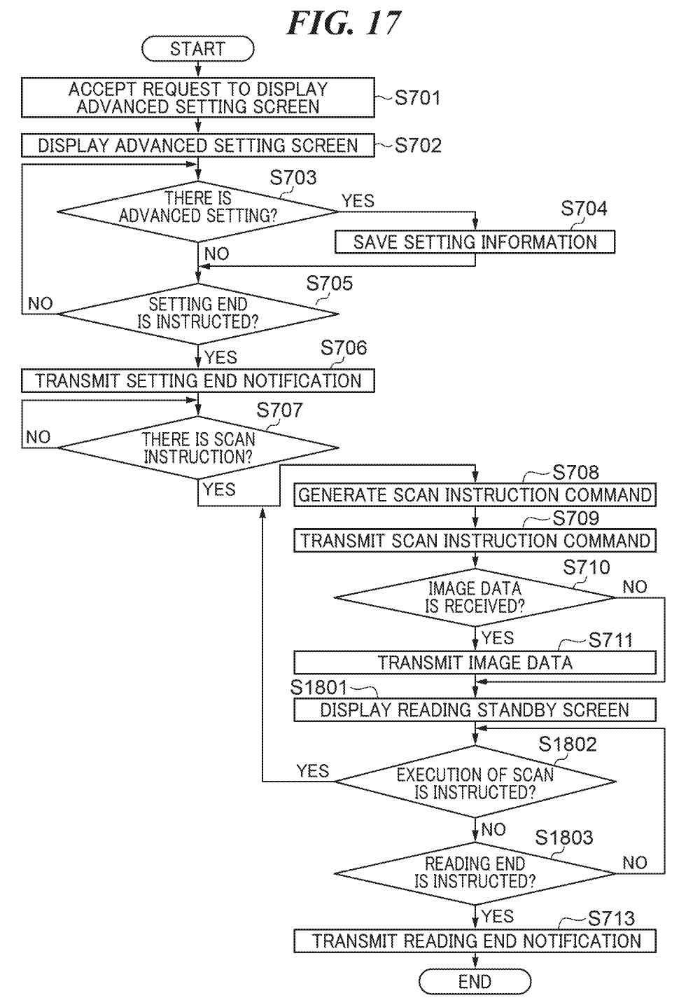

Hereinafter, a fifth embodiment will be described with reference to FIG. 16 and FIG. 17. Differences from the above-described embodiments will be mainly described, and description of the same matters will be omitted. In the first embodiment, during the continuous reading, the reading standby screen 1600 is displayed by the scanning apparatus 102, and an instruction to scan the next document is issued from the scanning apparatus 102. In the present embodiment, the reading standby screen 1600 is displayed by the expansion application 204, and an instruction to scan the next document is issued from the host computer 101.

FIG. 16 is a sequence chart illustrating a process executed among the scan application, the general-purpose scan software, the expansion application, and the scanning apparatus in the fifth embodiment after the scan application accepts a scan setting. The sequence chart illustrated in FIG. 16 is configured on the basis of the sequence chart illustrated in FIG. 6 by replacing the step S622 with the steps S1701 to S1703 and replacing the steps S627 and S628 with a step S1704. As illustrated in FIG. 16, in the step S1701, the expansion application 204 displays the reading standby screen 1600 (see FIG. 8B). Accordingly, the setting change of the reading conditions using the control 1601, the scan execution instruction using the control 1603, and the cancellation using the control 1604 can be accepted.

In the step S1702, the expansion application 204 generates a scan instruction command when the control 1603 on the reading standby screen 1600 is pressed. The reading conditions set by the control 1601 are reflected to the scan instruction command on the basis of the scan function information 203 in which the setting state on the advanced setting screen 300C is written in the step S607.

In the step S1703, the expansion application 204 transmits the scan instruction command generated in the step S1702 to the scanning apparatus 102.

In the step S1704, when the control 1604 on the reading standby screen 1600 is pressed, the expansion application 204 cancels the scan instruction, ends the continuous reading, and discontinues the display of the reading standby screen 1600.

FIG. 17 is a flowchart illustrating the process executed by the expansion application. The flowchart illustrated in FIG. 17 is configured on the basis of the flowchart illustrated in FIG. 7 by replacing the step S712 with steps S1801 to S1803. As illustrated in FIG. 17, in the step S1801, the expansion application 204 displays the reading standby screen 1600. The step S1801 corresponds to the step S1701 in FIG. 17.

In the step S1802, the expansion application 204 determines whether the control 1603 on the reading standby screen 1600 is pressed, that is, whether the execution of the scanning is instructed. As a result of the determination in the step S1802, when it is determined that the execution of the scanning is instructed, the process returns to the step S708, and the subsequent steps are sequentially executed. On the other hand, as a result of the determination in the step S1802, when it is determined that the execution of the scanning is not instructed, the process proceeds to the step S1803.

In the step S1803, the expansion application 204 determines whether the control 1604 on the reading standby screen 1600 is pressed, that is, whether the continuous reading end is instructed. As a result of the determination in the step S1803, when it is determined that the continuous reading end is instructed, the process proceeds to the step S713. On the other hand, as a result of the determination in the step S1803, when it is determined that the continuous reading end is not instructed, the process returns to the step S1802, and the subsequent steps are sequentially executed. As described above, in the present embodiment, the instruction to scan the next document can be issued from the host computer 101.

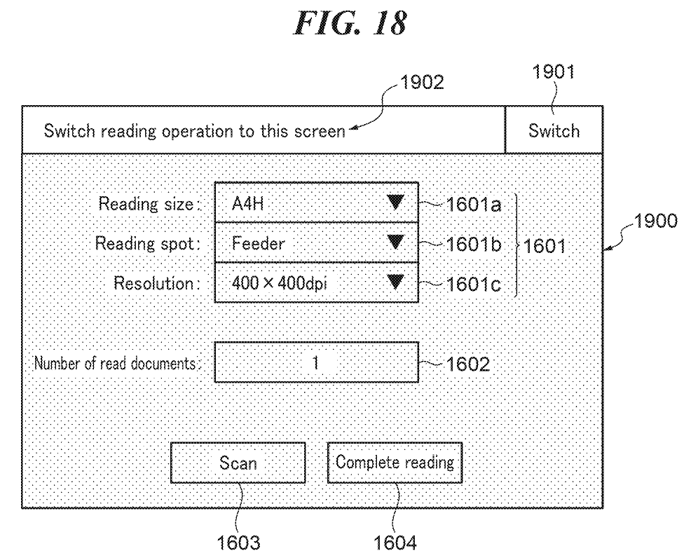

Hereinafter, a sixth embodiment will be described with reference to FIG. 18 to FIG. 20. Differences from the above-described embodiments will be mainly described, and description of the same matters will be omitted. FIG. 18 is a view illustrating an example of a reading standby screen 1900 displayed on the display unit of the scan system according to the sixth embodiment. In the present embodiment, the reading standby screen 1600 (see FIG. 8B) is displayed on one of the host computer 101 and the scanning apparatus 102, and the reading standby screen 1900 (see FIG. 18) is displayed on the other. The reading standby screen 1900 includes the controls 1601 to 1604 similarly to the reading standby screen 1600, but the controls 1601 to 1604 on the reading standby screen 1900 are grayed out and cannot be operated. Further, the reading standby screen 1900 includes a control 1901 and a message 1902. The control 1901 is only one operative control among all the controls. The message 1902 indicates that the press of the control 1901 switches the reading standby screen 1900 to the reading standby screen 1600 of which the controls 1601 to 1604 can be operated.

For example, the reading standby screen 1600 shall be displayed on the display unit 119 of the host computer 101 and the reading standby screen 1900 shall be displayed on the operation unit 194 of the scanning apparatus 102. In this state, the user can set the reading conditions only on the reading standby screen 1600 displayed on the display unit 119 of the host computer 101 and cannot set the reading conditions on the reading standby screen 1900. Then, when the user operates the control 1901 on the reading standby screen 1900 displayed on the operation unit 194 of the scanning apparatus 102, the displayed screens are switched. That is, the reading standby screen 1600 is displayed on the operation unit 194 of the scanning apparatus 102 and the reading standby screen 1900 is displayed on the display unit 119 of the host computer 101.

This allows the user to set the reading conditions from both the host computer 101 and the scanning apparatus 102 if needed. Further, the reading standby screen 1600 and the suppressed reading standby screen 1900 can be switched by the operation on the control 1901. This prevents the host computer 101 and the scanning apparatus 102 from simultaneously set the reading conditions.

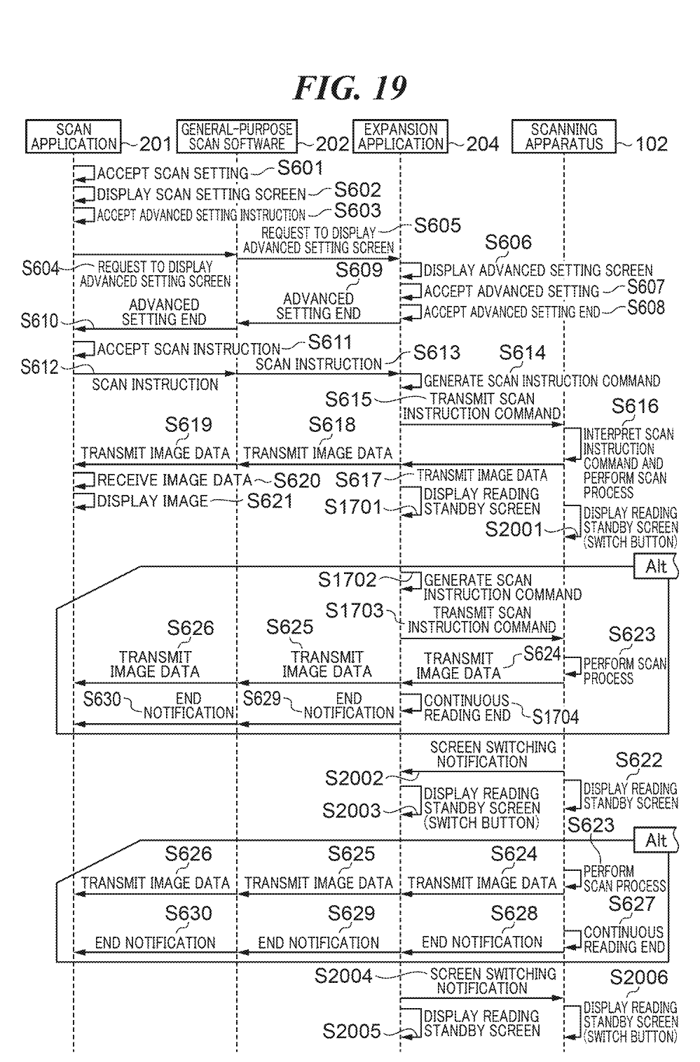

FIG. 19 is a sequence chart illustrating a process executed among the scan application, the general-purpose scan software, the expansion application, and the scanning apparatus after the scan application accepts a scan setting. The sequence chart illustrated in FIG. 19 is configured on the basis of the sequence chart illustrated in FIG. 16 by adding steps S2001 to S2006. As illustrated in FIG. 19, the step S2001 is executed together with the step S1701. In the step S2001, the CPU 191 of the scanning apparatus 102 displays the reading standby screen 1900 on the operation unit 194. This enables the reception of the switching by the control 1901 on the reading standby screen 1900.

When the control 1901 on the reading standby screen 1900 is pressed, the CPU 191 of the scanning apparatus 102 controls the input/output interface 198 to transmit a screen switching notification to the expansion application 204 in the step S2002. As a result, the suppressed reading standby screen 1900 displayed on the operation unit is switched to the reading standby screen 1600 (see the step S622).

In the step S2003, the expansion application 204 receives the screen switching notification transmitted from the scanning apparatus 102 in the step S2002 and displays the reading standby screen 1900 on the display unit 119 in place of the reading standby screen 1600.

When the control 1901 on the reading standby screen 1900 is pressed, the expansion application 204 controls the input/output interface 116 to transmit the screen switching notification to the scanning apparatus 102 in the step S2004.

In the step S2005, the expansion application 204 displays the reading standby screen 1600 on the display unit 119 in place of the reading standby screen 1900.

In the step S2006, the CPU 191 of the scanning apparatus 102 receives the screen switching notification transmitted from expansion application 204 in the step S2004 and displays the reading standby screen 1900 on the operation unit 194 in place of the reading standby screen 1600.

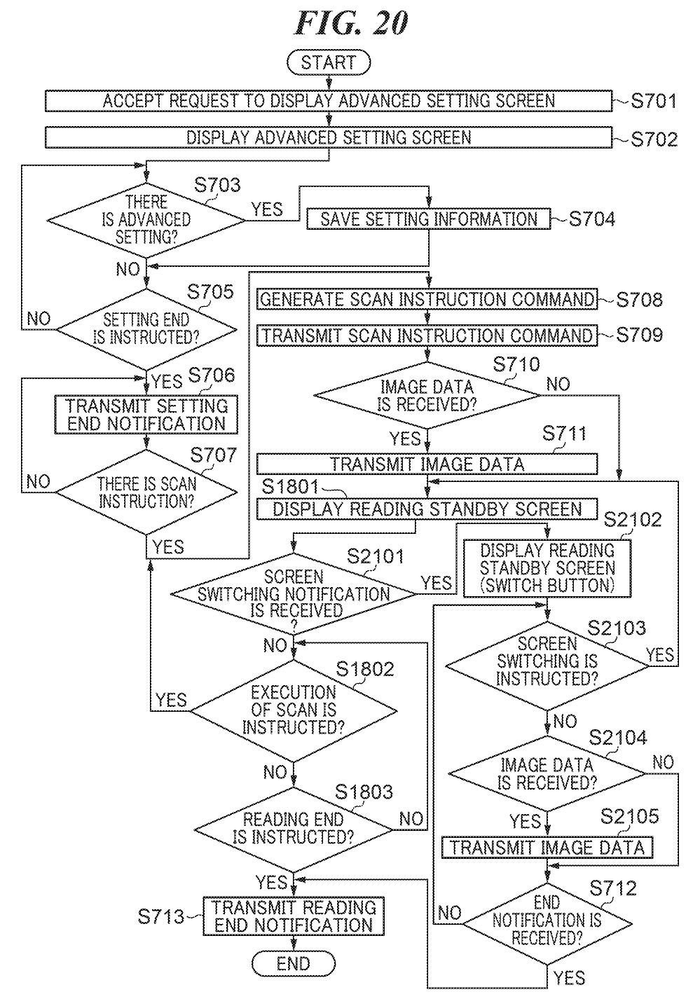

FIG. 20 is a flowchart illustrating the process executed by the expansion application. The flowchart illustrated in FIG. 20 is configured on the basis of the flowchart illustrated in FIG. 17 by inserting a step S2101 between the steps S1801 and S1802 and inserting steps S2102 to S2105 between the steps S2101 and S712. As illustrated in FIG. 20, in the step S2101, the expansion application 204 determines whether the screen switching notification is received from the scanning apparatus 102. As a result of the determination in the step S2101, when it is determined that the screen switching notification is received, the process proceeds to the step S2102. On the other hand, as a result of the determination in the step S2101, when it is determined that the screen switching notification is not received, the process proceeds to the step S1802.

In the step S2102, the expansion application 204 displays the reading standby screen 1900 including the control (button) 1901.

In the step S2103, the expansion application 204 determines whether the control 1901 on the reading standby screen 1900 is pressed, that is, whether the screen switching is instructed. As a result of the determination in the step S2103, when it is determined that the control 1901 is pressed, the process returns to the step S1801, and the subsequent steps are sequentially executed. On the other hand, as a result of the determination in the step S2103, when it is determined that the control 1901 is not pressed, the process proceeds to the step S2104.

In the step S2104, the expansion application 204 determines whether the image data is received from the scanning apparatus 102. As a result of the determination in the step S2104, when it is determined that the image data is received, the process proceeds to the step S2105. On the other hand, as a result of the determination in the step S2104, when it is determined that the image data is not received, the process proceeds to the step S712.

In the step S2105, the expansion application 204 transmits the image data determined in the step S2104 to the general-purpose scan software 202. After the step S2105 is executed, the process proceeds to the step S712.

In the step S712, the expansion application 204 determines whether the end of the continuous reading is received. As a result of the determination in the step S712, when it is determined that the continuous reading end is received, the process proceeds to step S713. On the other hand, as a result of the determination in the step S712, when it is determined that the continuous reading end is not received, the process returns to the step S2103, and the subsequent steps are executed in order.

According to the present disclosure, an application program supporting a standard driver can issue a first instruction to an image processing apparatus to read a first document, can issue a second instruction to the image processing apparatus to read a second document following the first document after reading the first document, and can make image data of the first document read based on the first instruction and image data of the second document read based on the second instruction into one file.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-201646, filed November 19, 2024 which is hereby incorporated by reference herein in its entirety.

What is claimed is:

1. A non-transitory computer-readable storage medium storing an application program comprising:
supporting a standard driver provided from a provider of an operating system of an information processing apparatus;
causing the information processing apparatus to execute a control method comprising:
causing a display to display a reception screen on which a second instruction that instructs an image processing apparatus to read a second document following a first document after reading the first document based on a first instruction that instructs the image processing apparatus to read the first document; and
making image data of the first document read based on the first instruction and image data of the second document read based on the second instruction into one file.

2. The non-transitory computer-readable storage medium according to claim 1, wherein the control method further comprising:
causing a display to display a read setting screen that receive a read setting; and
causing a display to display, in response to reception of a predetermined setting on the read setting screen, the reception screen on which the second instruction that instructs the image processing apparatus to read the second document following the first document after reading the first document based on the first instruction that instructs the image processing apparatus to read the first document.

3. The non-transitory computer-readable storage medium according to claim 2, wherein the predetermined read setting is a setting of a continuous reading function.

4. The non-transitory computer-readable storage medium according to claim 1, wherein a read setting of the second document read based on the second instruction can be accepted on the reception screen.

5. The non-transitory computer-readable storage medium according to claim 4, wherein the read setting of the second document includes at least one of a reading size and a reading resolution.

6. The non-transitory computer-readable storage medium according to claim 1, wherein the standard driver causes the information processing apparatus to obtain capability information of the image about the image processing apparatus according to an Internet Printing Protocol.

7. The non-transitory computer-readable storage medium according to claim 1, wherein the standard driver causes the information processing apparatus to transmit the first instruction and the second instruction to the image processing apparatus according to an Internet Printing Protocol.

8. A control method for an information processing apparatus by executing an application program supporting a standard driver provided from a provider of an operating system of the information processing apparatus, the control method comprising:
causing a display to display a reception screen on which a second instruction that instructs an image processing apparatus to read a second document following a first document after reading the first document based on a first instruction that instructs the image processing apparatus to read the first document; and
making image data of the first document read based on the first instruction and image data of the second document read based on the second instruction into one file.

9. An information processing apparatus comprising:
a display control unit configured to display a reception screen on which a second instruction that instructs an image processing apparatus to read a second document following a first document after reading the first document based on a first instruction that instructs the image processing apparatus to read the first document by executing an application program supporting a standard driver provided from a provider of an operating system of the information processing apparatus; and
a control unit configured to make image data of the first document read based on the first instruction and image data of the second document read based on the second instruction into one file.
